(19) United States
(12) Patent Application Publication
(10) Pub. No.: US 2025/0070617 A1
(43) Pub. Date: Feb. 27, 2025

(54) DEVICES AND SYSTEMS FOR PASSIVE HARVESTING OF ELECTRICITY FROM MECHANICAL SHOCK EVENTS AND VIBRATIONAL ENERGY

(71) Applicant: WePower Technologies LLC, Sagaponack, NY (US)

(72) Inventors: Michael Joseph Riddell, Clastonbury, CT (US); Jeffrey Charles Andle, Orlando, FL (US)

(21) Appl. No.: 18/812,914

(22) Filed: Aug. 22, 2024

Related U.S. Application Data
(60) Provisional application No. 63/578,072, filed on Aug. 22, 2023.
(60) Provisional application No. 63/578,079, filed on Aug. 22, 2023.

(51) Int. Cl. H02K 7/18; G01P 1/07; H02K 5/02; H02K 35/02

(52) U.S. Cl. CPC H02K 7/1876; G01P 1/07; H02K 5/02; H02K 35/02

(57) ABSTRACT

In some aspects, the devices, systems and methods described herein include an energy harvesting devices that include a housing, first magnet and/or spring provided at a first end of the housing, a second magnet and/or spring provided at a second end of the housing, a free magnet that is configured to oscillate between one or more turns of wire in response to a vibration of the housing, which causes a voltage to be induced between terminal ends of the turns of wire. In some aspects, the terminal ends of the turns of wire can be coupled to a passive energy harvesting circuit that is configured to rectify/filter the voltage produced by the device, store the energy in passive storage components (e.g., capacitors) and use the stored energy to communicate information regarding the vibrations to a user device (e.g., via RF communication).

### CROSS-REFERENCE TO RELATED APPLICATIONS

This application claims priority under 35 U.S.C. § 119 (e) to U.S. Provisional Application No. 63/578,072, titled ELECTROMECHANICAL ENERGY HARVESTER FOR ENERGY FROM A MECHANICAL SHOCK and filed on Aug. 22, 2023, and to U.S. Provisional Application No. 63/578,079, titled ELECTROMECHANICAL ENERGY HARVESTER FOR VIBRATIONAL ENERGY and filed on Aug. 22, 2023, the entire contents of each of which are hereby expressly incorporated by reference herein.

### FIELD

The subject matter described herein relates to passive energy harvesting devices capable of converting mechanical energy from vibrations and impact events into electrical energy which can be used to autonomously power electronics for purposes such as to generate electrical signals and log noteworthy vibration/impact events.

### BACKGROUND

U.S. Pat. No. 9,673,683 B2, dated Jun. 6, 2017, to Deak and incorporated herein by reference in its entirety, discloses an exemplary reciprocating magnet electrical generator using a plunger or button to release a normally-bound free magnet. The described generator further uses two counter magnets to suspend and constrain said free magnet, via repulsive magnetic forces, to act as a nominal spring-like response. Said free magnet is nominally suspended proximate an induction coil for an interval of time during the button press. The mass of the magnet and the effective magnetic “spring” constant of the constraining suspension magnets determine a resonant frequency and mechanical impedance of the system. Such a generator can be well suited to obtaining a short burst of electrical energy from a discrete button press in an exemplary aspect.

U.S. Pat. No. 9,843,248 B2 dated Dec. 12, 2017, also to Deak, discloses a bistable rocker arm system which may be used to discrete mechanical event signaling in an exemplary implementation.

U.S. Pat. No. 10,348,160 B2, dated Jul. 9, 2019, also to Deak, discloses an exemplary rotational magnet generator. This system may be tangentially actuated by a discrete mechanical event or by release of stored magnetic energy from a pre-wound state.

### SUMMARY

In one aspect, an energy harvesting device is provided that is capable of converting mechanical energy from vibrations experienced by the device into electrical energy which can be used to autonomously power electronics for purposes such as to generate electrical signals and log noteworthy vibration events. The energy harvesting device may include a housing, a first magnet provided at a first end of the housing, a second magnet provided at a second end of the housing, wherein the first magnet and the second magnet are aligned along a first axis, a free magnet provided between the first magnet and the second magnet along the first axis, wherein the first magnet, the free magnet and the second magnet arranged such that the free magnet is repelled by both the first magnet and the second magnet, thereby causing the free magnet to oscillate between the first magnet and the second magnet along the first axis in response to a vibration of the housing, and one or more turns of wire provided circumferentially around the first axis between the first magnet and the second magnet, each of the one or more turns of wire having a first terminal end and a second terminal end, wherein oscillation of the free magnet between the first magnet and the second magnet along the first axis induces a voltage across the first terminal end and the second terminal end.

In some aspects, the energy harvesting device can also include an adjustment mechanism operatively coupled to the first magnet and arranged to allow for adjustment of a distance between the first magnet and the second magnet along the first axis.

In some aspects, the housing can also include a hollow shaft arranged to house the free magnet and wherein interior walls of the hollow shaft are textured such that air or debris within the shaft can pass by the free magnet as it oscillates, thereby minimizing viscous damping of the oscillation of the free magnet. In some aspects, the texture of the interior walls of the hollow shaft is any one of slotted, spined, rifled, ridged or fluted.

In some aspects, the housing can also include a hollow shaft arranged to house the free magnet and the energy harvesting device can also include: a plurality of springs operatively coupling the free magnet to the interior of the hollow shaft, wherein the plurality of springs are oriented in parallel along the first axis and each have a first stiffness along the first axis and a relatively higher second stiffness along a second axis that is perpendicular to the first axis. In some aspects, the plurality of springs are planar springs.

In some aspects, a center of the free magnet along the first axis is hollow. In some aspects, the energy harvesting device can also include a wire or a rod extending though the center of the free magnet and arranged to guide the oscillatory motion of the free magnet along the first axis.

In some aspects, the energy harvesting device can also include a low magnetic reluctance material disposed circumferentially outside of the one or more turns of wire. In some aspects, the low magnetic reluctance material is a soft iron.

In some aspects, the energy harvesting device is coupled to an asset and wherein the free magnet is arranged to oscillate between the first magnet and the second magnet along the first axis in response to a vibration of the asset. In some aspects, the asset is any one of a machine, a machine component or a vehicle. In some aspects, the asset is a shipping container or pallet.

In some aspects, the energy harvesting device can also include: an electronics module electrically coupled to the first terminal end and the second terminal end of the one or more turns of wire, wherein the voltage induced across the first terminal end and the second terminal end of the one or more turns of wire is arranged to power the electronics module to transmit a data characterizing the vibration to an external device.

In some aspects, the energy harvesting device can also include one or more sensors electrically coupled to the electronics module, wherein the voltage induced across the first terminal end and the second terminal end of the one or more turns of wire is further arranged to power the one or more sensors to acquire metadata corresponding to the vibration and wherein the electronics module is arranged to transmit the metadata to the external device.

In some aspects, the one or more sensors comprise an accelerometer and the metadata comprises a peak acceleration of the energy harvesting device.

In another aspect, another energy harvesting device is provided that is capable of converting mechanical energy from vibrations and impact events experienced by the device into electrical energy which can be used to autonomously power electronics for purposes such as to generate electrical signals and log noteworthy vibration/impact events. In some aspects, energy harvesting device can include a housing, a first magnet provided at a first end of the housing, a free magnet provided between the first magnet and a second end of the housing along a first axis, wherein the first magnet and the free magnet arranged such that the free magnet is repelled by the first magnet, and a collar provided at the second end of the housing, wherein the collar is made from a magnetic material such that an attractive magnetic force is generated between the collar and the free magnet that is sufficient to retain the free magnet in a normally bound state proximal to the collar, and one or more turns of wire provided circumferentially around the first axis between the first magnet and the second end, each of the one or more turns of wire having a first terminal end and a second terminal end, wherein, responsive to an impact force on the housing that exceeds the attractive magnetic force, the free magnet is arranged to separate from the normally bound state and oscillate between the first magnet and the second end along the first axis, thereby inducing a voltage across the first terminal end and the second terminal end.

In some aspects, the energy harvesting device can also include: a shaft extending through the collar along the first axis and having a first end coupled to a second magnet, wherein the free magnet and the second magnet are arranged such that the free magnet is repelled by the second magnet, and a spring operatively coupled to the shaft, wherein the shaft and the spring are in a loaded state when the free magnet is in the normally bound state, wherein a spring force of the spring in the loaded state is less than the attractive magnetic force between the collar and the free magnet, wherein, responsive to the impact, the shaft and the spring are arranged to extend into an unloaded state causing the shaft to propel the second magnet toward the first magnet.

In some aspects, the shaft can also include a second end opposite the first end that protrudes from the second end of the housing wherein, after the free magnet is separated from the normally bound state, a user can pull the second end of the shaft to cause the shaft and the spring to move from the unloaded state to the loaded state, thereby reestablishing the normally bound state.

In some aspects, the energy harvesting device can also include an adjustment mechanism operatively coupled to the spring and arranged to allow for adjustment of the loaded state, thereby adjusting the spring force.

In some aspects, the collar is arranged to short circuit a magnetic field of the second magnet when the free magnet is in the normally bound state.

In some aspects, the energy harvesting device is coupled to an asset and the vibration or the impact force are generated by or experienced by the asset. In some aspects, the asset is any one of a machine, a machine component, or a vehicle. In some aspects, the asset is a shipping container or pallet.

In some aspects, the housing can also include a hollow shaft arranged to house the free magnet and wherein interior walls of the hollow shaft are textured such that air or debris within the shaft can pass by the free magnet as it oscillates, thereby minimizing viscous damping of the oscillation of the free magnet. In some aspects, the texture of the interior walls of the hollow shaft is any one of slotted, spined, rifled, ridged or fluted.

In some aspects, the housing can also include a hollow shaft arranged to house the free magnet and the energy harvesting device can also include: a plurality of springs operatively coupling the free magnet to the interior of the hollow shaft, wherein the plurality of springs are oriented in parallel along the first axis and each have a first stiffness along the first axis and a relatively higher second stiffness along a second axis that is perpendicular to the first axis. In some aspects, the plurality of springs are planar springs.

In some aspects, a center of the free magnet along the first axis is hollow. In some aspects, the energy harvesting device can also include a wire or a rod extending though the center of the free magnet and arranged to guide the oscillatory motion of the free magnet along the first axis.

In some aspects, the energy harvesting device can also include a flange provided at the second end of the housing between the free magnet and the collar when the free magnet is in the normally bound state.

In some aspects, the energy harvesting device can also include a low magnetic reluctance material disposed circumferentially outside of the one or more turns of wire. In some aspects, wherein the low magnetic reluctance material is a soft iron.

In some aspects, the energy harvesting device can also include: an electronics module electrically coupled to the first terminal end and the second terminal end of the one or more turns of wire, wherein the voltage induced across the first terminal end and the second terminal end of the one or more turns of wire is arranged to power the electronics module to transmit a data characterizing the vibration or the impact force to an external device.

In some aspects, the energy harvesting device can also include one or more sensors electrically coupled to the electronics module, wherein the voltage induced across the first terminal end and the second terminal end of the one or more turns of wire is further arranged to power the one or more sensors to acquire metadata corresponding to the vibration or the impact force and wherein the electronics module is arranged to transmit the metadata to the external device.

In some aspects, the one or more sensors include an accelerometer and the metadata comprises a peak acceleration of the energy harvesting device.

In another aspect, another energy harvesting device is provided. In some aspects, energy harvesting device can include a housing, a first spring provided within the housing, a second spring provided within the housing, wherein the first spring and the second spring are oriented in parallel along a first axis and each have a first stiffness along the first axis and a relatively higher second stiffness along a second axis that is perpendicular to the first axis, a first magnet operatively coupled to the first spring and the second spring along the first axis, wherein the first magnet is confined along the first axis by said first and second springs and is arranged to oscillate along said first axis in response to a vibration of the housing, and one or more turns of wire provided on the housing, circumferentially around the first axis, each of the one or more turns of wire having a first terminal end and a second terminal end, wherein oscillation of the first magnet along the first axis induces a voltage between the first terminal end and the second terminal end.

In some aspects, the first spring and the second spring are planar springs.

In some aspects, the energy harvesting device can also include: an annular shutter provided at the first end of the housing and coupled to the first spring, wherein the annular shutter is arranged to variably extend from an outer circumference of the first spring, uniformly toward a center of the first spring, along the second axis to partially constrain oscillatory motion of the first spring along the first axis thereby altering the first stiffness. In some aspects, the energy harvesting device can also include: a second annular shutter provided at the second end of the housing and coupled to the second spring, wherein the second annular shutter is arranged to variably extend from an outer circumference of the second spring, uniformly toward a center of the second spring, along the second axis to partially constrain oscillatory motion of the second spring along the first axis thereby altering the second stiffness.

In some aspects, the housing can also include a hollow shaft arranged to house the first magnet and wherein interior walls of the hollow shaft are textured such that air or debris within the shaft can pass by the first magnet as it oscillates, thereby minimizing viscous damping of the oscillation of the first magnet. In some aspects, the texture of the interior walls of the hollow shaft includes any one of slotted, spined, rifled, ridged or fluted.

In some aspects, the energy harvesting device can also include a non-conductive connector (e.g., a magnetically non-conductive connector) extending between the first spring and the second spring and arranged to operatively couple the first magnet to the first spring and the second spring.

In some aspects, the energy harvesting device can also include a low magnetic reluctance material disposed circumferentially outside of the one or more turns of wire. In some aspects, wherein the low magnetic reluctance material is a soft iron.

In some aspects, the energy harvesting device is coupled to an asset and wherein the first magnet is arranged to oscillate along the first axis in response to a vibration of the asset. In some aspects, wherein the asset is any one of a machine, a machine component or a vehicle. In some aspects, wherein the asset is a shipping container or pallet.

In some aspects, the energy harvesting device can also include: an electronics module electrically coupled to the first terminal end and the second terminal end of the one or more turns of wire, wherein the voltage induced across the first terminal end and the second terminal end of the one or more turns of wire is arranged to power the electronics module to transmit a data characterizing the vibration to an external device.

In some aspects, the energy harvesting device can also include one or more sensors electrically coupled to the electronics module, wherein the voltage induced across the first terminal end and the second terminal end of the one or more turns of wire is further arranged to power the one or more sensors to acquire metadata corresponding to the vibration and wherein the electronics module is arranged to transmit the metadata to the external device.

In some aspects, the one or more sensors include an accelerometer and the metadata comprises a peak acceleration of the energy harvesting device.

In another aspect, another energy harvesting device is provided. In some aspects, energy harvesting device can include a housing, a first spring (e.g., a magnetically non-conductive spring) provided within the housing, a second spring (e.g., a magnetically non-conductive spring) provided within the housing, wherein the first spring and the second spring are oriented in parallel along a first axis and each have a first stiffness along the first axis and a relatively higher second stiffness along a second axis that is perpendicular to the first axis, a first magnet operatively coupled to the first spring and the second spring along the first axis, a magnet material coupled to the first spring, a second magnet provided at a first end of the housing along the first axis, wherein a first attractive magnetic force is generated between the second magnet and the magnetic material coupled to said first spring that is sufficient to retain the first spring, the second spring and the first magnet in a first pretensioned state, and one or more turns of wire provided on the housing, circumferentially around the first axis, each of the one or more turns of wire having a first terminal end and a second terminal end, wherein, responsive to an impact force on the housing that exceeds the attractive magnetic force, the first spring is arranged to separate from the first pretensioned state causing the first magnet to oscillate along the first axis, thereby inducing a voltage between the first terminal end and the second terminal end.

In some aspects, the first spring and the second spring are planar springs.

In some aspects, the housing can also include a first adjustable cap coupled to the second magnet and arranged to allow for adjustment of a distance between the second magnet and the first spring along the first axis, thereby adjusting a first binding strength of the first pretensioned state.

In some aspects, the energy harvesting device is arranged such that, after the first spring, the second spring and the first magnet are separated from the first pretensioned state and oscillate along the first axis, a user can press the second spring toward the first spring, causing the magnetic material to recouple to the second magnet by way of the first attractive magnetic force, returning the first spring, the second spring and the first magnet to the first pretensioned state.

In some aspects, responsive to the first spring separating from the first pretensioned state, the first spring, the second spring and the first magnet are arranged to perform a single oscillation before the magnetic material to recouple to the second magnet, thereby returning the first spring, the second spring and the first magnet to the first pretensioned state.

In some aspects, the housing can also include a second adjustable cap coupled to a third magnet provided at the second end of the housing, wherein the third magnet is arranged to retain the first spring, the second spring and the first magnet in a second pretensioned state by way of a second attractive magnetic force between the third magnet and a magnetic material coupled to the second spring, and wherein the second adjustable cap is arranged to allow for adjustment of a distance between the third magnet and the second spring along the first axis, thereby adjusting a second binding strength of the second pretensioned state.

In some aspects, responsive to the first spring separating from the first pretensioned state, the first spring, the second spring and the first magnet are arranged to perform a first half oscillation before the second spring couples to the third magnet, placing the first spring, the second spring and the first magnet in the second pretensioned state.

In some aspects, responsive to the second spring separating from the second pretensioned state, the first spring, the second spring and the first magnet are arranged to perform a second half oscillation before the first spring recouples to the second magnet, returning the first spring, the second spring and the first magnet to the first pretensioned state.

In some aspects, the energy harvesting device is coupled to an asset and the impact force is generated by or experienced by the asset. In some aspects, the asset is any one of a machine, a machine component or a vehicle. In some aspects, the asset is a shipping container or pallet.

In some aspects, the housing can also include a hollow shaft arranged to house the first magnet and wherein interior walls of the hollow shaft are textured such that air or debris within the shaft can pass by the first magnet as it oscillates, thereby minimizing viscous damping of the oscillation of the first magnet. In some aspects, the texture of the interior walls of the hollow shaft is any one of slotted, spined, rifled, ridged or fluted.

In some aspects, the energy harvesting device can also include a non-conductive connector (e.g., a magnetically non-conductive connector) extending between the first spring and the second spring and arranged to operatively couple the first magnet to the first spring and the second spring.

In some aspects, the energy harvesting device can also include a low magnetic reluctance (e.g., magnetically conductive) material disposed circumferentially outside of the one or more turns of wire. In some aspects, wherein the low magnetic reluctance material is a soft iron.

In some aspects, the energy harvesting device can also include: an electronics module electrically coupled to the first terminal end and the second terminal end of the one or more turns of wire, wherein the voltage induced across the first terminal end and the second terminal end of the one or more turns of wire is arranged to power the electronics module to transmit a data characterizing the vibration to an external device.

In some aspects, the energy harvesting device can also include one or more sensors electrically coupled to the electronics module, wherein the voltage induced across the first terminal end and the second terminal end of the one or more turns of wire is further arranged to power the one or more sensors to acquire metadata corresponding to the vibration and wherein the electronics module is arranged to transmit the metadata to the external device.

In some aspects, the one or more sensors comprise an accelerometer and the metadata comprises a peak acceleration of the energy harvesting device.

### BRIEF DESCRIPTION OF THE DRAWINGS

These and other features will be more readily understood from the following detailed description taken in conjunction with the accompanying drawings, in which:

FIG. 1 is a block diagram of an exemplary energy harvesting system according to the subject matter described herein;

FIGS. 2A-2B are partial section views of another exemplary aspect of an energy harvesting device/energy generator according to the subject matter described herein that is configured to generate electrical energy in response to significant vibrations or impacts that are experienced by the device or an asset that the device is coupled to;

FIGS. 3A-3B are partial section views of another aspect of an energy harvesting device according to the subject matter described herein that is configured to generate electrical energy in response to significant vibrations or impacts and in response to vibrations that are experienced by the device or an asset that the device is coupled to;

FIG. 3C is a partial section view of another aspect of an energy harvesting device according to the subject matter described herein that is configured to generate electrical energy in response to vibrations that are experienced by the device or an asset that the device is coupled to;

FIG. 4 is a diagram illustrating a variation of components that can be used in combination with the energy harvesting devices described herein;

FIG. 5 is a diagram illustrating another variation of components that can be used in combination with the energy harvesting devices described herein;

FIG. 6A is an isometric view of another aspect of an energy harvesting device according to the subject matter described herein;

FIGS. 6B-6D are cross sectional views of the energy harvesting device of FIG. 6A, as seen from a section A-A of FIG. 6A;

FIGS. 7A-7B are isometric views of another aspect of an energy harvesting device according to the subject matter described herein;

FIGS. 7C-7D are partial sectional views of energy harvesting device of FIGS. 7A-7B;

FIG. 8A is a partial section view of another exemplary aspect of an energy harvesting device/energy generator according to the subject matter described herein;

FIGS. 8B-8D are cross sectional views of the energy harvesting device of FIG. 8A, as seen from a section B-B of FIG. 8A;

FIG. 8E is a partial section view of another exemplary aspect of an energy harvesting device/energy generator according to the subject matter described herein;

FIGS. 8F-8H are cross sectional views of the energy harvesting device of FIG. 8E, as seen from a section C-C of FIG. 8E; and

FIG. 9 is a diagram illustrating an exemplary design of a planar spring according to the subject matter described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Many conventional asset monitoring sensors and devices require active power sources in the form of batteries and/or electrical wirings, which can consume energy even in cases when the asset is operating properly and is not generating any alerts. Devices that are battery powered can require routine battery replacement, while wired devices provide an additional component of “clutter” in a production environment and can also suffer from severed connections, water damage, etc. Furthermore, current passive energy harvesting devices, like the technologies described above in the background section of this application, suffer from frictional losses, especially in cases where the reciprocating magnets of these devices have non-vertical alignment. For example, the free magnets of the technologies described above experience mechanical losses as they move, due to contact with side walls of the devices, buildup of debris, and back pressure and viscous damping caused by trapped air moving around the free magnets. These adverse effects are worsened if the axis of motion deviates from vertical, as the force of gravity causes the free magnet to pull along the sidewalls. These adverse effects remove mechanical energy from the system without contributing to electrical power generation. Additionally, the technologies described above can suffer from stiction effects due to resting contact between the free magnet and the sidewalls, which require an additional amount of force to overcome and to allow for the free magnet to move to generate electrical energy.

The devices, systems and methods described herein mitigate the limitations described above by providing stand-alone, passive energy harvesting capabilities that can generate electrical energy from vibrations in their environment that can be used to self-power the devices to send signals to other devices when noteworthy vibrational patterns or impact events occur in the environment that the device is monitoring. The devices, systems and methods described herein minimize or eliminate contact between moving magnets of the devices with the shafts that they move within. In some aspects, the devices, systems and methods described herein include an energy harvesting devices that include a housing, first magnet and/or spring provided at a first end of the housing, a second magnet and/or spring provided at a second end of the housing, a free magnet that is configured to oscillate between one or more turns of wire in response to a vibration of the housing, which causes a voltage to be induced between terminal ends of the turns of wire. In some aspects, the terminal ends of the turns of wire can be coupled to a passive energy harvesting circuit that is configured to rectify/filter the voltage produced by the device, store the energy in passive storage components (e.g., capacitors) and use the stored energy to communicate information regarding the vibrations, as well as meta data recorded by a variety of application specific sensor types, to a user device (e.g., via RF communication), as described below.

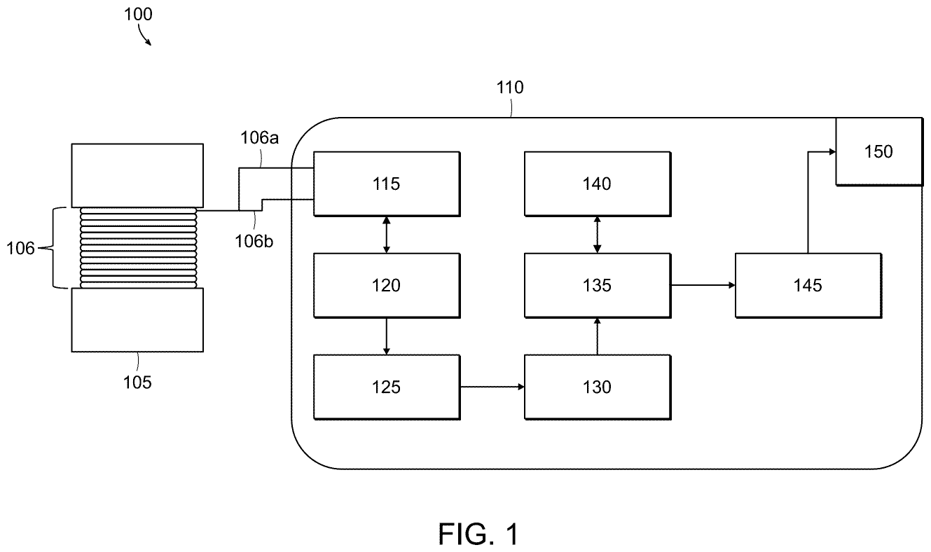

FIG. 1 is a block diagram of an exemplary energy harvesting system 100 configured to generate energy from mechanical energy which can be used to power a variety of application specific outputs. In some aspects, the energy harvesting system 100 includes an energy generator 105 and an electronics module 110. The energy generator 105 can take on several different aspects, the details of which are described in greater detail below. The energy generator 105 can be coupled to the electronics module 110 via terminal ends 106a, 106b of a coil of wire 106 of the energy generator. In response to a vibration or impact event experienced by the energy generator 105, a voltage can be induced between the terminal ends 106a, 106b of the coil of wire 106, as described in greater detail below, which can be sent to the electronics module 110. In some aspects, the electronics module 110 can include a rectifier 115, a DC-DC converter 120, a bulk energy storage 125, a voltage regulator 130, a micro controller 135, a sensor 140, an RF transmitter 145 and an antenna 150. In some aspects, the terminal ends 106a, 106b of the coil of wire 106, can be operatively coupled to the rectifier 115, which can be configured to rectify the voltage that is generated by the generator 105 into a Direct Current (DC) voltage. In some aspects, the rectified voltage can then be sent to the DC-DC converter 120 and then on to the bulk energy storage 125. The bulk energy storage 125 and the voltage regulator 130 can be configured to buffer intermittent or impulsive voltage into constantly available stored energy to be supplied to the microcontroller 135. In some aspects, the bulk energy storage 125 can include a plurality of physical bulk capacitors, where a connection of the plurality of physical bulk capacitors can be reconfigured into one or more series configurations or one or more parallel configurations. In some aspects, the bulk energy storage 125 can be a battery. In some aspects, the microcontroller 135 can act as a central processing unit of the system 100, which runs firmware or software to process data from the generator 105 and/or the sensor 140 and control the RF transmitter 145. In some aspects, the microcontroller 135 can be powered by the regulated voltage, provided by the voltage regulator 130, to gather data from the sensor 140.

In some aspects, the energy harvesting system 100 can be used in a method where the system 100 is mounted to a host object (e.g., a shipping pallet or a compressor, as described below) such that the axis of the free magnet travel path is aligned with the vibration axis of interest. In some aspects, unrectified or rectified waveforms may be optionally monitored as indications of the vibration signal and the signals may be analyzed to determine properties of the vibration, as described herein. For example, in some aspects, the sensor 140 can be an accelerometer (e.g., a MEMS accelerometer) that can be configured to transmit acceleration data to the microcontroller 135 when the microcontroller 135 is powered by the voltage generated by the energy generator 105. For example, the acceleration data can include a peak acceleration of the energy harvesting system 100. The microcontroller can process the acceleration data and send signals to the RF transmitter 145, which can be configured to convert the signal into an RF signal. The RF signal generated by the RF transmitter 145 can be broadcast by the antenna 150 as RF output. However, the use of other sensor types is also realized. For example, if an application requires a temperature reading every time the energy generator 105 generates a voltage (e.g., in response to a vibration or an impact, as described below), then the sensor 140 can be a temperature sensor that is configured to transmit a temperature reading in the environment of the system 100 to the microcontroller 135 when the microcontroller 135 is powered by the voltage generated by the energy generator 105. In another case, if an application requires an air pressure reading every time the energy generator 105 generates a voltage, then the sensor 140 can be a pressure sensor that is configured to transmit a pressure reading in the environment of the system 100 to the microcontroller 135 when the microcontroller 135 is powered by the voltage generated by the energy generator 105. In another case, if an application requires a photo of the environment of the system 100 every time the energy generator 105 generates a voltage, then the sensor 140 can be a camera that is configured to capture and transmit a photo when the microcontroller 135 is powered by the voltage generated by the energy generator 105. In another case, if an application requires knowledge of a location of the item to which the system 100 is attached, then the sensor 140 can be a GPS sensor that is configured to transmit the location of the system 100 to the microcontroller 135 when the microcontroller 135 is powered by the voltage generated by the energy generator 105. In this case, the location data can then be transmitted to an external tracking system, via the RF transmitter 145/antenna 150. Accordingly, the system 100 can be modified to include any sensor type that may be required for the application that it is being used for.

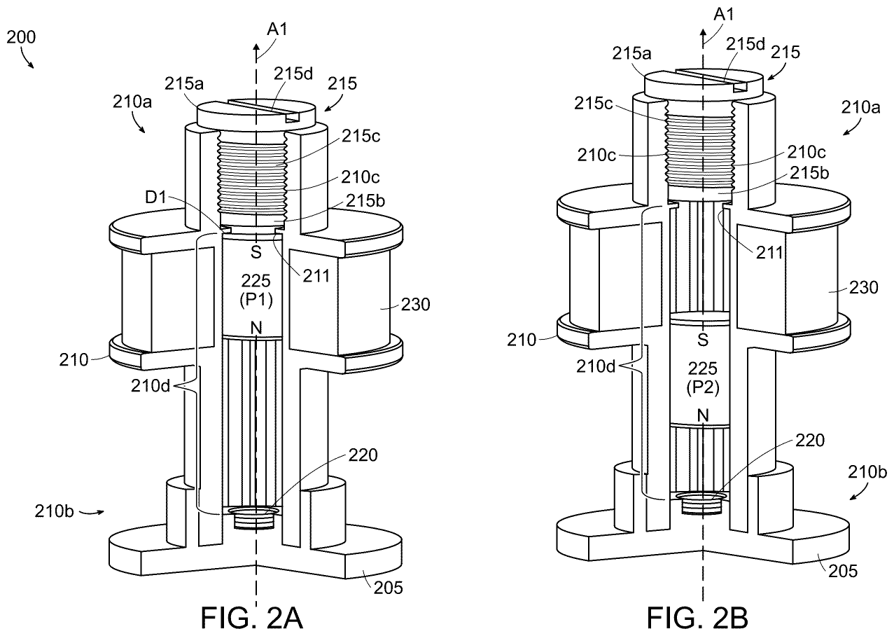

FIGS. 2A-2B are partial section views of an exemplary aspect of an energy harvesting device/energy generator 200 that is configured to generate electrical energy in response to vibrations or impact events that exceed a predetermined threshold frequency or force. Energy harvesting devices that are designed to only generate energy in response to vibrations or impact events that exceed a predetermined threshold frequency or force can be used, for example, to alert users of irregularities in a machine that is being monitored or to alert a user if a package (e.g., a shipping crate) has been dropped or has experienced another sort of noteworthy impact that may have damaged the contents of the package. In some aspects, the energy harvesting device 200 can include a base 205 that is configured to aid in coupling the device 200 to an asset. Depending on the application, the asset that the device 200 is coupled to can include an industrial machine or machine component. For example, in some aspects the asset can be a pump or compressor or the like, and the device 200 can be coupled to the asset and configured to harvest energy from natural vibrations of the asset in order to provide information about the operation of the asset. In another example, the asset can be a vehicle, and the device 200 can be configured to generate energy from vibrations experienced by the vehicle as it moves. In yet another example, the asset can be a shipping container or crate that is housing something that requires safe handling. In this case, the device 200 can be coupled to the container/crate and can be configured to generate energy as the container/crate experiences vibrations or impact events. In any of the examples provided above, the device 200 can act as a vibration/impact sensor and can be configured to log vibration/impact events that are experienced by the asset which can then be viewed by an operator or user to determine if the asset has experienced significant impacts or irregular vibrations that can be indicative of damage or something wrong with the asset.

As shown in FIGS. 2A-2B, the energy harvesting device 200 can also include a housing 210, a collar 215 provided at a first end of the housing 210a, a stationary magnet 220 provided at a second end of the housing 210b, a free magnet 225 that is provided between the collar 215 and the stationary magnet 220. In some aspects, the collar 215 can be made from a magnetic material that is configured to attract the free magnet 225 during operation of the device 200, as described in greater detail below. The collar 215, the stationary magnet 220 and the free magnet 225 can be aligned along a first axis A1. Additionally, the stationary magnet 220 and the free magnet 225 can be arranged such that the free magnet 225 is repelled by the stationary magnet 220. For example, as shown in FIGS. 2A-2B, the free magnet 225 includes north and south poles, with the south pole of the free magnet 225 being oriented upward. Additionally, while not shown in FIGS. 2A-2B, the stationary magnet 220 also includes north and south poles. Accordingly, for the free magnet 225 to be repelled by the stationary magnet 220, the poles of the stationary magnet can be oriented opposite to the poles of the free magnet 225. For example, in FIGS. 2A-2B, the north pole of the stationary magnet is configured to face the north pole of the free magnet 225. However, it should be noted that the orientations of the free magnet 225 and the stationary magnet 220 could be opposite to as shown in FIGS. 2A-2B.

During operation, the free magnet 225 of the energy harvesting device 200 can be placed in a bound state P1, as shown in FIG. 2A. In the bound state P1, an attractive magnetic force can be generated between the collar 215 and the free magnet 225 that is sufficient to retain the free magnet 225 in the bound state P1, proximal to the collar 215. In some aspects, the device 200 further includes a flange 211 that is configured to act as an upper boundary of movement for the free magnet 225. The free magnet 225 is configured to rest on the flange 211 when it is placed in the bound state P1. In some aspects, the collar 215 can be a threaded screw having a first end 215a, a second end 215b and male threads 215c that are configured to mesh with female threads 210c within the housing 210 to allow for adjustment of a distance D1 between the second end 215b of the collar 215 and the free magnet 225. Accordingly, the attractive magnetic force can be adjusted (e.g., by a user) by rotating the threaded collar 215 about a first axis A1, thereby changing the distance D1 between the second end 215b of the collar 215 and the free magnet 225, as the attractive magnetic force is inversely proportional to the distance D1 between the free magnet 225 that is held to flange 211 and the second end 215b of the collar 215. Therefore, the distance D1 determines the threshold shock level at which the free magnet 225 will release from the flange 211 and oscillate. For example, the attractive magnetic force can be increased by minimizing the distance D1 between the second end 215b of the collar 215 and the free magnet 225, and thus increasing the shock activation level at which free magnet 225 will release. Similarly, the attractive magnetic force can be decreased by unscrewing the collar 215 such that the second end 215b of the collar 215 is moved away from the free magnet 225, and thus decreasing the shock activation level at which free magnet 225 will release. For example, the first end 215a of the collar 215 can include a recess 215d that can be engaged by a screwdriver or the like to screw in/out the collar 215 within the housing 210. In some aspects, the collar 215 can simply be adjusted by hand. In some aspects, the flange 211 can define the minimum distance D1.

In some aspects, the second end of the housing 210b can be coupled to the base 205 which can be coupled to the asset, as described above, such that any vibrations or impacted events that are experienced by the asset can be transmitted to the device 200. The energy harvesting device 200 also includes one or more turns of wire 230 provided on the housing 210, circumferentially around the first axis A1 and between the collar 215 and the stationary magnet 220. The one or more turns of wire 230 have a first terminal end and a second terminal end (not shown), which can be coupled to an electronics module of the energy harvesting device 200 (e.g., the electronics module 110 of FIG. 1).

The free magnet 225 can be configured to remain in the bound state P1, until the energy harvesting device 200 (or the asset to which the device 200 is coupled to) experiences a vibration or impact that is greater than the attractive force between the collar 215 and the free magnet 225. Responsive to a vibration or impact force on the energy harvesting device 200 that exceeds the attractive force, the free magnet 225 can be configured to separate from the bound state, as shown in FIG. 2B. When the free magnet 225 separates from the bound state P1, it accelerates down toward the stationary magnet 220. In some aspects, once the free magnet 225 is set into motion and is accelerated toward the stationary magnet 220, it encounters a repelling force by the stationary magnet 220, causing it to decelerate, stop, rebound and accelerate back toward the collar 215 where it will come to rest. The motion action of the free magnet 225 during this event causes significant time-rate change of magnetic flux through the turns of wire 230, thereby inducing a voltage across the first terminal end and the second terminal end of the one or more turns of wire 230. In some aspects, the voltage that is induced in the one or more turns of wire 230 can be transmitted to an electronics module of the energy harvesting device 200 (e.g., the electronics module 110 of FIG. 1) and can be used to power the electronics module to transmit an alert of the vibration or impact event that exceed the attractive force between the collar 215 and the free magnet 225, as described above.

In some aspects, once the free magnet 225 is separated from the bound state P1, accelerates toward the stationary magnet 220 and rebounds from the stationary magnet 220 back toward collar 215, inducing a voltage in the one or more turns of wire 230, as described above, it can require a manual reset to the bound state P1 before it is able to detect a sequential “impact” or “shock” event. Alternatively, in some aspects the device 200 can be tuned such that, after the free magnet 225 is separated from the bound state P1, the free magnet 225 is configured to perform a single oscillation along the first axis A1, from the collar 215, down to the stationary magnet 220, as shown in FIG. 2B, where it is repelled by the stationary magnet 220, causing it to move back up the first axis and is recaptured by the collar 215, via the attractive force. In this case, after the free magnet 225 completes the single oscillation, the free magnet 225 is configured to recouple to the collar 215, thereby returning the free magnet to the bound state P1. This design can be particularly advantageous in a case where the energy harvesting device 200 is monitoring a shipping pallet throughout a duration of its travel, where the pallet may routinely experience noteworthy vibrational or impact events that need to be logged or transmitted. Accordingly, in this case, once the free magnet 225 is separated from the collar 215, the voltage generated by the single oscillation of the free magnet 225 can generate enough power to send a signal to the user to alert them of the event, as described above in reference to FIG. 1, before reestablishing the bound state P1, without having to be rest by the user.

As described above, adjusting the distance D1 between the second end 215b of the collar 215 and the free magnet 225 alters the retention force of the device 200. The smaller D1, the stronger the attractive force between the free magnet 225 to and the collar 215 and thus the more energy that is required to break the free magnet 225 free from the flange 211. For example, in the case where the energy harvesting device 200 is coupled to a shipping pallet that contains fragile goods, the attractive force can be adjusted by the user to trigger the free magnet 225 to decouple from the bound state P1 in response to an impact that exceeds a threshold value that is indicative of the container being dropped or otherwise mishandled in a way that may result in the contents therein being damaged.

In some cases, in order to further constrain the motion of the free magnet 225 to the first axis A1, the housing 210 can also include a hollow shaft 210d configured to house the free magnet 225 as it oscillates between the collar 215 and the stationary magnet 220. In some aspects, a diameter of the hollow shaft 210d can designed to have a tight tolerance with the free magnet 225. In some aspects, interior walls of the hollow shaft 210d can be textured or have features that minimize viscous damping of the oscillation of the free magnet 225 due to air resistance on the free magnet 225 as it oscillates. For example, interior walls of the hollow shaft 210d can be slotted, spined, rifled, ridged or fluted, as shown in FIG. 2. The slots, spines, rifles, ridges, flutes or other grooves formed in the hollow shaft 210d can provide areas of larger cross-section, allowing for displaced air to pass around the free magnet 225, reducing aerodynamic drag due to finite air viscosity. By providing slotted, spined, rifled, ridged or fluted features in the hollow shaft 210d, a communication path can be established for air to pass through as the free magnet moves within the shaft, thereby eliminating and pressure differences on top and bottom sides of the free magnet 225. The texturing of the interior walls of the hollow shaft 210d can also advantageously allow for any debris that exists within the shaft 210d to pass into the slots, spines, etc. within the interior walls of the hollow shaft 210d, such that the motion of the free magnet 225 is unobstructed. For example, in some cases, an interaction between the free magnet 225 rubbing against the walls of the shaft 210d as it oscillates can cause material from either the shaft 210d or the free magnet 225 to wear off into the shaft 210d, resulting in debris. Such debris can have deleterious dampening effects on the oscillation of the free magnet 225 if not properly managed. Texturing the interior walls of the shaft 210d, as described above, provides a volume into which wear particulates may settle and be diverted away from the tighter tolerance between the free magnet 225 and the walls of the shaft 210d. In some aspects, the slots, spines, rifles, ridges, flutes or other grooves may be straight along the axis of motion A1, or may spiral around the axis of motion A1.

In some aspects, aerodynamics may also be improved by hollowing out the free magnet 225 along its axis of motion A1 (not shown). In this case, the energy harvesting device 200 can further include a wire or a rod (not shown) that extends within the hollow shaft 210d, from the collar 215 to the stationary magnet 220, though the hollow center of the free magnet 225, such that the free magnet 225 is guided during its oscillatory motion along the first axis. In some aspects, the wire/rod that extends within the hollow shaft 210d can also be textured to allow for diversion of air and debris, as described above. Additionally, by hollowing out the free magnet 225 along the axis A1, the free magnet 225 can have a smaller mass, and therefore a higher resonant frequency, which can be advantageous for some energy harvesting applications. In some aspects, a center of the free magnet 225 can be hollow along the first axis In some aspects, the wire/rod (and/or an interior wall of the hollow free magnet 225) can be provided with a low wear, low friction coating (e.g., a diamond-like carbon coating) to reduce friction and wear losses at the interface between the wire/rod and the interior wall of the hollow free magnet 225.

In some aspects, a first air flow channel (not shown) can be provided along the first axis A1 from a top surface of the free magnet 225 through the first end 215a of the collar 215 and a second air flow channel (not shown) can be provided along the first axis A1 from a bottom surface of the free magnet 225 through the base 205. By providing the first and second air flow channels, as described above, air that is displaced by the free magnet 225 can be flown out of the first and second air flow channels, thereby reducing aerodynamic drag without having to texture the walls of the hollow shaft 210d or hollow out a center of the free magnet 225. This design allows for a the spacing between the free magnet 225 and the one or more turns of wire 230 to be reduced and a magnetic flux of the free magnet 225 to be maximized.

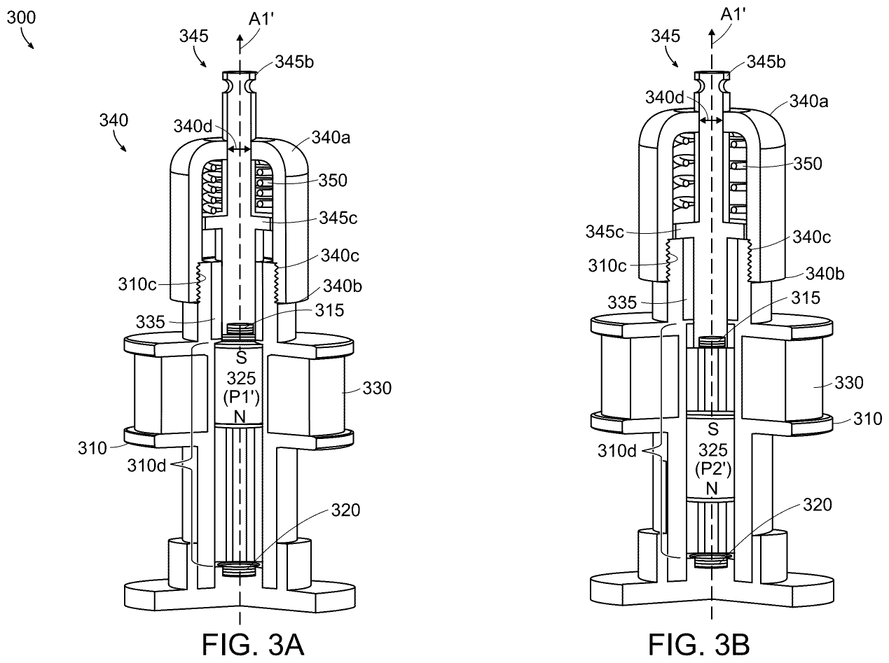

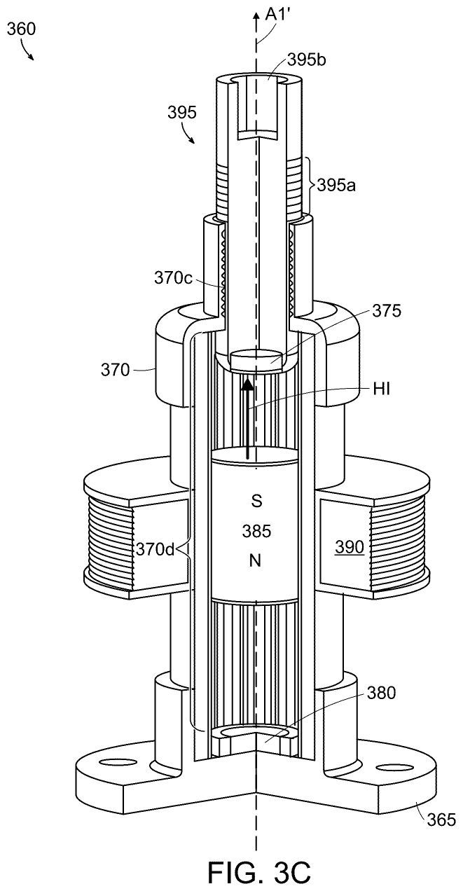

FIGS. 3A-3B are partial section views of another aspect of an energy harvesting device 300 that is configured to generate electrical energy in response to significant vibrations or impacts that are experienced by the device 300 or an asset that the device 300 is coupled to. As shown in FIGS. 3A-3B, the energy harvesting device 300 can include a housing 310, a first magnet 315, a second magnet 320, a free magnet 325 and one or more turns of wire 330 provided on the housing 310, which can be coupled to an electronics module. The first magnet 315, the second magnet 320 and the free magnet 325 can be aligned along a first axis A1′, and can be arranged such that the free magnet 325 is repelled by both the first magnet 315 and the second magnet 320. For example, as shown in FIGS. 3A-3B, the free magnet 325 includes north and south poles, with the south pole of the free magnet 325 being oriented upward. Additionally, while not shown in FIGS. 3A-3B, the first magnet 315 and the second magnet 320 also include north and south poles. Accordingly, for the free magnet 325 to be repelled by both the first magnet 315 and the second magnet 320, the poles of the first magnet 315 and the second magnet 320 can be oriented opposite to the poles of the free magnet 325. For example, in FIGS. 3A-3B, the first magnet 315 can be arranged such that the south pole thereof faces the south pole of the free magnet 325. Similarly, the second magnet 320 can be arranged such that the north pole thereof faces the north pole of the free magnet 325. However, it should be noted that the orientations of the free magnet 325 and the first and second magnets 315, 320 could be opposite to as shown in FIGS. 3A-3B.

The energy harvesting device 300 can also include a collar 335 that is provided at a first end of the housing 310. In some aspects, the collar 335 can be made from a magnetic material that is configured to attract the free magnet 325, as described in greater detail below. The energy harvesting device 300 also includes an end cap 340 provided at the first end of the housing 310. The end cap 340 can include a first end 340a and a second end 340b, with female threads 340c provided on an interior wall of the second end 340b of the end cap 340. The female threads 340c are configured to mesh with male threads 310c provided on an exterior of the housing 310. The energy harvesting device 300 can also include a shaft 345 that is configured to extend within the end cap 340, along the first axis A1′. The shaft can include a first end 345a that is coupled to the first magnet 315 and a second end 345b, opposite the first end 345a, that protrudes from an opening 340d within the first end 340a of the end cap 340. The shaft 345 also includes a flange 345c that is configured to contact a top of the collar 340 to limit movement of the shaft 345 and the first magnet 315 along the first axis A1′ when the shaft moves from a loaded state, as shown in FIG. 3A into an unloaded state, as shown in FIG. 3B, as will be described in greater detail below. The energy harvesting device 300 can also include a spring 350 that is provided within the end cap 340 and that circumferentially surrounds the shaft 345. The spring 350 can be constrained axially, along the first axis A1′, between the first end 340a of the end cap 340 and the flange 345c of the shaft 345.

During operation, the free magnet 325 can be placed in a normally bound state P1′, as shown in FIG. 3A. In the normally bound state, an attractive magnetic force can be generated between the collar 335 and the free magnet 325 that is greater than any residual repulsive force that is generated between the first magnet 315 and the free magnet 325. Specifically, when the free magnet 325 is in the normally bound state P1′, the first magnet 315 is moved upward, as shown in FIG. 3A, such that the collar 335 circumferentially surrounds the first magnet 315, thereby short circuiting the magnetic fields of the magnet 315. Accordingly, with the magnetic fields of the magnet 315 being short circuited, the attractive magnetic force between the collar 335 and the free magnet 325 is sufficient to retain the free magnet 325 in the normally bound state P1′, proximal to the collar 335, as shown in FIG. 3A. When the free magnet 325 is in the normally bound state P1′, the shaft 345 is forced upward, thereby compressing the spring 350 between the first end 340a of the end cap 340 and the flange 345c of the shaft 345 and establishing a loaded state of the shaft 345 and the spring 350, as shown in FIG. 3A. When the free magnet 325 is in the normally bound state and the shaft 345 and the spring 350 are in the loaded state, a resultant binding force is established to retain the free magnet 315 in the normally bound state. The resultant binding force has a binding strength defined by the attractive magnetic force between the collar 335 and the free magnet 325 minus the spring force that is generated by the spring 350 in the loaded state and minus any residual repulsive force that is generated between the first magnet 315 and the free magnet 325.

In some aspects, the resultant binding force can be adjusted (e.g., by a user) by rotating the end cap 340 about the first axis A1′, thereby moving the end cap 340 closer to or further away from the second magnet 320, by way of the female threads 340c of the end cap 340 and the male threads 310c of the housing 310. For example, the resultant binding force can be increased by rotating the end cap 340 such that the end cap 340 moves away from the second magnet 320, thereby reducing the amount of compression of the spring 350 in the loaded state. Similarly, the resultant binding force can be decreased by rotating the end cap 340 such that the end cap 340 moves toward the second magnet 320, thereby increasing the amount of compression of the spring 350 in the loaded state.

The free magnet 325 can be configured to remain in the normally bound state, with the shaft 345 and the spring 350 remaining in the loaded state, until the energy harvesting device 300 experiences a vibration or impact that is greater than the resultant binding force. Responsive to a vibration or impact force on the energy harvesting device 300 that exceeds the resultant binding force, the free magnet 325 can be configured to separate from the normally bound state into an unbound state P2′, as shown in FIG. 3B. When the free magnet 325 separates from the normally bound state, the spring 350 is no longer being held in the loaded state and therefore begins to decompress into an unloaded state. As the spring 350 decompresses from the loaded state into the unloaded state, it acts on the flange 345c of the shaft 345, causing the shaft 345 to extend the first magnet 315 downward toward the second magnet 320 until the flange 345c comes into contact with the top of the collar 335, as shown in FIG. 3B. As the first magnet 315 is extended downward toward the second magnet 320, the first magnet 315 is no longer circumferentially surrounded by the collar 335, which causes the magnetic fields of the first magnet 315 to act on the free magnet 325, as they are no longer being short circuited by the collar 335. Accordingly, once the free magnet 325 is separated from the normally bound state, it will oscillate between the first magnet 315 and the second magnet 320 along the first axis, as shown in FIG. 3B, thereby inducing a voltage across the first terminal end and the second terminal end of the one or more turns of wire 330. In some aspects, the voltage that is induced in the one or more turns of wire 330 can be transmitted to an electronics module of the energy harvesting device 300 (e.g., the electronics module 110 of FIG. 1) and can be used to power the electronics module to transmit an alert of the vibration or impact event that exceed the predetermined threshold, as described above. For example, in a case where the energy harvesting device 300 is coupled to a shipping container that contains fragile goods, the resultant binding force can be adjusted by the user to trigger the free magnet 315 to decouple from the normally bound state in response to an impact that exceeds a threshold value that is indicative of the container being dropped or otherwise mishandled in a way that may result in the contents therein being damaged.

When the shaft 345 and the spring 350 release from the loaded state, as shown in FIG. 3A, into the unloaded state, as shown in FIG. 3B, the first magnet 315 is moved by the shaft 345 and the spring 350, from a loaded position, as shown in FIG. 3A, to an unloaded position, as shown in FIG. 3B. Therefore, the flange 345c is placed at a location on the shaft 345 such that the repulsive force between the first magnet 315 and the free magnet 325, when the first magnet is in the unloaded state, is greater than the attractive force between the collar 335 and the free magnet 325. This allows the free magnet 325 to oscillate between the first magnet 315 and the second magnet 320 without being drawn back into the normally bound state by the collar 335. In some aspects, a distance between the first magnet 315 and the free magnet 325 can determine a first effective spring constant and a distance between the second magnet 320 and the free magnet 325 can determine a second effective spring constant. Together, the first and second effective spring constants can establish an effective average stiffness for the device 300. In some aspects, the effective average stiffness and the mass of the free magnet 325 can determines the resonant frequency of the oscillations of the device 300. In some aspects, the resonant frequency can have little significance when the device 300 is tuned to monitor impact or single shock events. However, in cases where the device 300 is tuned to monitor vibrational energy after an impact or single shock event, additional energy can be harvested by the device 300 when the vibrational energy has vibration frequency within a given range of the resonant frequency.

In some aspects, once the free magnet 325 is separated from the normally bound state and oscillates between the first magnet 315 and the second magnet 320, inducing a voltage in the one or more turns of wire 330, as described above, it can require a manual reset before it is able to detect a sequential “impact” or “shock” event. Accordingly, in some aspects, once the free magnet 325 is separated from the normally bound state and oscillates between the first and second magnets 315, 320 to generate a voltage that is used to send an alert of the impact or shock, a user can pull the second end 345b of the shaft 345 to cause the first magnet 315 to move from the unloaded state, as shown in FIG. 3B, back into a loaded state, as shown in FIG. 3A when the free magnet 325 is in the normally bound position P1′. By moving the first magnet 315 from the unloaded state to the loaded state, the magnetic fields of the magnet 315 are again short circuited by way of being circumferentially surrounded by the collar 335, and the attractive force between the collar 335 and the free magnet 325 is reestablished and can once again exceed the repulsive force between the first magnet 315 and the free magnet 325. In addition to the attractive force experience by free magnet 325 due to magnetic collar 325, the repulsive force of second magnet 320 acting on free magnet 325, additionally contributes to acceleration of free magnet 325 toward the loaded position P1′. This movement causes the free magnet 325 to recouple to the collar 335, thereby reestablishing the normally bound state P1′. However, in some aspects, after an initial impact event that is sufficient to cause the free magnet to separate from the normally bound state P1′ into an unbound state P2′, the free magnet 325 can continue to oscillate between the first and second magnets 315, 320 in response to any vibrations that are experienced by the device 300 after the initial impact event. Therefore, any oscillatory motion of the free magnet 325 between the first and second magnets 315, 320 after the initial impact event can still induce a voltage across the first terminal end and the second terminal end of the one or more turns of wire 330, which can be used to power the electronics module, as described above. For example, in some cases the device 300 can act as an earthquake sensor. In this case, the free magnet 325 can be tuned to separate from the normally bound state P1′ into an unbound state P2′ in response to an initial earth tremor, to induce a first voltage in the coils and can then continue oscillate thereafter to generate secondary voltages in the coils during subsequent tremors.

Furthermore, in some aspects, the housing 310 can also include a hollow shaft 310d configured to house the free magnet 325 as it oscillates between the first magnet 315 and the second magnet 320. The hollow shaft 310d can be designed to have a similar texture or have features that are similar to the hollow shaft 210d of energy harvesting device 200, accordingly, like components are not described.

In some aspects, by removing the collar 340 and the spring 350, the device 300 of FIGS. 3A-3B can be modified to constantly generate electrical energy from vibrations in the environment that the device is provided in, as shown in FIG. 3C. FIG. 3C is a partial section view of another aspect of an energy harvesting device 360 that is configured to generate electrical energy in response to vibrations that are experienced by the device or the asset that the device is coupled to. Depending on the application, the asset that the device 360 is coupled to can be any asset that experiences vibration, similarly to as described above.

In some aspects, the components of the device 360 can be similar to those of device 300 described above, accordingly, like components are not described. For example, the energy harvesting device 360 can include a housing 370, a first magnet 375, a second magnet 380, a free magnet 385 and one or more turns of wire 390, which can have similar constructions and arrangements to the housing 310, first magnet 315, second magnet 320, free magnet 325 and one or more turns of wire 330 of device 300.

During operation, responsive to any vibrational motion experienced by the device 360, the free magnet 385 is configured to oscillate between the first magnet 375 and the second magnet 380 along the first axis A1′, which then induces a voltage across the first terminal end and the second terminal end of the one or more turns of wire 390, which can be sent to the electronics module, and processed as described above. The energy harvesting device 360 can also include an adjustment mechanism 395 that is operatively coupled to the first magnet 375, as shown in FIG. 3C. In some aspects, the adjustment mechanism 395 can be a threaded screw having male threads 395a that are configured to mesh with female threads 370c within the housing 370 to allow for adjustment of a height H1 between the first magnet 375 and the second magnet 380 along the first axis A1′. For example, the adjustment mechanism 395 can include a recess 395b that can be engaged by a screwdriver/wrench, or the like, to screw in/out the adjustment mechanism 395 within the housing 370 to move the first magnet 375 toward/away from the second magnet 380. In some aspects, the adjustment mechanism 395 can simply be adjusted by hand. Adjusting the spacing H1 directly alters the magnetic forces between the first magnet 375, the free magnet 385 and the second magnet 380, and therefore the equivalent spring constant. Shorter heights H1 can increase frequency of the oscillations of the free magnet 385, but also constrain a time variance of magnetic flux by limiting a total travel distance of the free magnet 385. Depending on the application that the device 360 is being used for, adjusting the height H1 between the first magnet 375 and the second magnet 380 via the adjustment mechanism 395 can increase/decrease a strength of the magnetic fields generated between the first magnet 375, the free magnet 385 and the second magnet 380. For example, increasing the height H1 will increase the total travel distance of the free magnet 385 and decrease the magnetic forces acting on the free magnet 385, leading to a reduction in the oscillation frequency. Alternatively, decreasing the height H1 will decrease the total travel distance of the free magnet 385 and increase the magnetic forces acting on the free magnet 385, leading to an increase in the oscillation frequency. Accordingly, the adjustment mechanism 395 can be used to fine tune the energy harvesting device 360 for the specific application.

In some cases, the housing 370 can also include a hollow shaft 370d which can be designed similarly to the hollow shaft 310d. Additionally, in some aspects, the free magnet 385 can be hollowed out along its axis of motion A1′ and/or can further include a wire or a rod (not shown) that extends within the hollow shaft 370d to guide the free magnet 385 during its oscillatory motion, similarly to as described above. Furthermore, In some aspects, a first air flow channel (not shown) can be provided along the first axis A1′ from a top surface of the free magnet 385 through the adjustment mechanism 395, and a second air flow channel (not shown) can be provided along the first axis A1′ from a bottom surface of the free magnet 385 through a base 365 of the housing, similarly to as described above, in reference to FIGS. 2A-2B. By providing the first and second air flow channels, as described above, air that is displaced by the free magnet 385 can be flown out of the first and second air flow channels, thereby reducing aerodynamic drag without having to texture the walls of the hollow shaft 370d or hollow out a center of the free magnet 385. As described above, this design allows for a the spacing between the free magnet 385 and the one or more turns of wire 390 to be reduced and a magnetic flux of the free magnet 385 to be maximized.

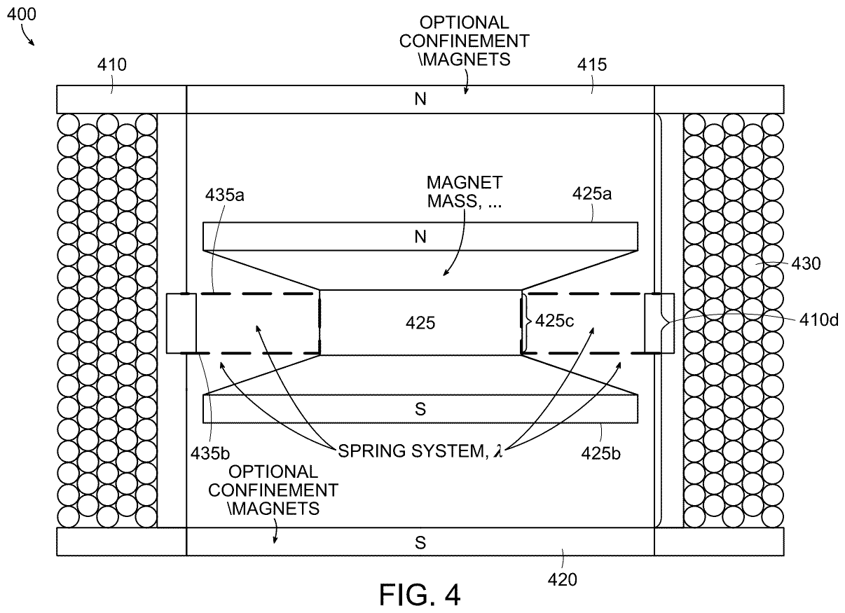

FIG. 4 is a diagram illustrating components of an energy harvesting device/energy generator 400 that is configured to generate electrical energy from vibrations in the environment that the generator 400 is provided in. In some aspects, the energy harvesting device 400 can be a similar variation to the designs of the energy harvesting devices of FIGS. 2-3B described above, accordingly, like components will not be described. The components of the energy harvesting device 400 can also include a housing 410, a first magnet 415, a second magnet 420, a free magnet 425 and one or more turns of wire 430 provided on the housing 410, similarly to as described above. Additionally, the components of the energy harvesting device 400 can include a plurality of springs 435a, 435b that are configured to circumferentially surround and operatively couple the free magnet 425 to the interior of a hollow shaft 410d of the housing. In some aspects, the plurality of springs 435a, 435b can be planar springs, similar to as described above, that are oriented in parallel along a first axis (e.g., axis A1 of FIG. 2). In some aspects, the plurality of springs 435a, 435b can each have a first stiffness along the first axis and a relatively higher second stiffness along any second axis that is perpendicular to the first axis to allow for the magnet 425 to oscillate along the first axis, but remain relatively constrained from any oscillatory motion along any said defined second axis. Accordingly, the radial stiffness with respect to first axis of the plurality of springs 435a, 435b on the free magnet 425 help to constrain the motion of the free magnet 425 to the first axis, while the first and second magnets 415, 420 primarily determine the mechanical impedance and resonant frequency of the oscillatory motion of the free magnet 425. In this case, the combination of the magnetic confinement provided by the first and second magnets 415, 420 and the mechanical confinement provided by the plurality of springs 435a, 435b provides an additional advantage of limiting the overall displacement of the free magnet 425 along the first axis in response to larger amplitudes of vibration experienced by the device 400. Additionally, by using the plurality of springs 435a, 435b, any rocking motion of the free magnet 425 can also be minimized, which is especially beneficial when the vibrations or impact events that are experienced by the device 400 are not directly aligned with the first axis (e.g., multi-axis vibration, elliptical vibration, etc.). In particular, a device may be operated horizontally with sufficient radial stiffness and not suffer contact between the free magnet and bore walls.

As shown in FIG. 4, in some aspects, the free magnet 425 can include an upper face 425a configured to face the first magnet 415 and a lower face 425b configured to face the second magnet 420. Additionally, the free magnet can include a central groove 425c along a radial center thereof to provide more room for the plurality of springs 435a, 435b that are placed between the free magnet 425 and the interior wall of the housing, without reducing a width of the upper and lower faces 425a, 425b of the free magnet 425. This arrangement advantageously allows for a separation between the upper and lower faces 425a, 425b of the free magnet 425 and the one or more turns of wire 430 to be reduced.

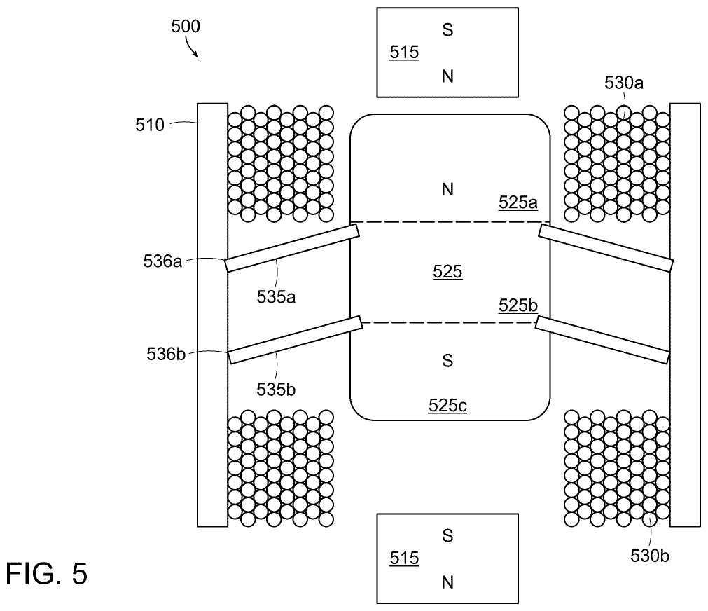

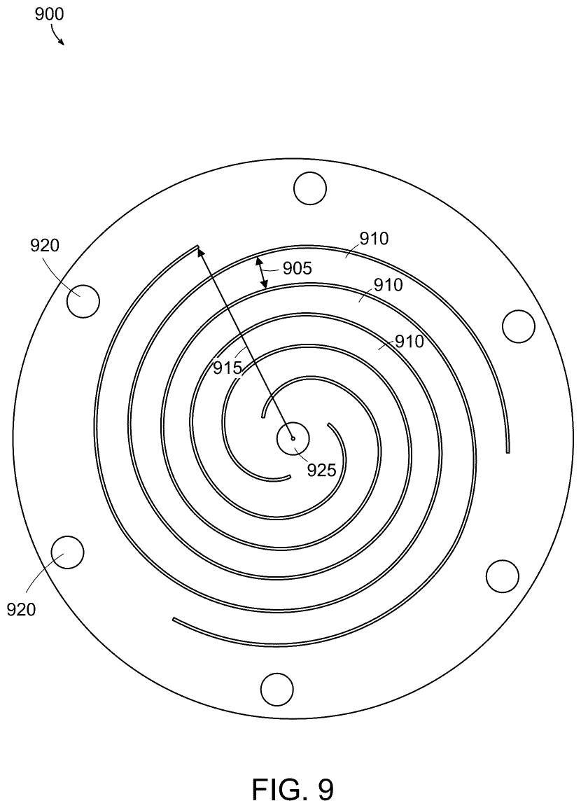

FIG. 5 is another diagram illustrating components of an energy harvesting device/energy generator 500 that is configured to generate electrical energy from vibrations in the environment that the generator 500 is provided in. In some aspects, the energy harvesting device 500 can be a similar variation to the designs of the energy harvesting devices of FIGS. 2-4 described above, accordingly, like components will not be described. The components of the energy harvesting device 500 can also include a housing 510, a first magnet 515, a second magnet 520, a free magnet 525 and one or more turns of wire 530a, 530b, similarly to as described above. However, the variation provided by the energy harvesting device 500, if applied to the designs of any of the energy harvesting devices described above, advantageously allows for the omission of the toleranced hollow shaft of the housing (e.g., hollow shaft 210d of FIG. 2). For example, as shown in FIG. 5, the one or more turns of wire 530a, 530b of the energy harvesting device 500 are provided on an interior wall of the housing 510. Additionally, the components of the energy harvesting device 500 can include a plurality of springs 535a, 535b configured to operatively couple the free magnet 525 to the interior wall of the housing 510. In some aspects, the plurality of springs 535a, 535b can be planar springs that are similar to springs described above in reference to FIG. 4. In some aspects, the springs 535a, 535b may include tabs 536a, 536b and the housing 510 can include corresponding slots that allow for the tabs 536a, 536b of the springs 535a, 535b to that snap into the slots. This design can advantageously reduce parts and assembly labor. Additionally, in some aspects, the free magnet 525 can be divided into three sections that are divided along sections of the free magnet 525 that are in contact with the springs 535a, 535b. In this case, the springs 535a, 535b can be provided in between the three divided sections and the divided sections of the free magnet 525 can be coupled to one another through holes that are provided through a center of the springs 535a, 535b (e.g., through a central hole 925 of a spring 900 as discuss below in reference to FIG. 9) in order to fasten the springs 535a, 535b. As shown in FIG. 5, the one or more turns of wire 530a, 530b that are provided on the interior of the housing 510 can be separated into an upper coil 530a and a lower coil 530b. The plurality of springs 535a, 535b can be provided axially between upper coil 530a and a lower coil 530b and can be configured to couple the free magnet 525 to the interior wall of the housing. In some aspects, the repulsive forces of the first and second magnets 515, 520 on the free magnet 525 can help to prevent the plurality of springs 535a, 535b from colliding with the one or more turns of wire 530a, 530b at high displacements of the free magnet 525. Additionally, in this aspect, the housing 510 can include an outer shell that surrounds the one or more turns of wire 530a, 530b and that is made from a low reluctance material (e.g., a material with high magnetic permeability) that is configured to maximize magnetic flux coupling to the one or more turns of wire 530a, 530b while also physically supporting the one or more turns of wire 530a, 530b and springs 535a, 535b. In some aspects, the low reluctance material can be any of iron, steel, nickel, cobalt and ferrites, however this list is not exhaustive, and the use of any other known low reluctance materials are also realized.

In some aspects, the springs may have tabs that snap into slots formed in the housing for reduced assembly labor. For embodiments as illustrated in FIG. 5 the magnet 525 may comprise three partial submagnets 525a-c stacked with the springs 535a and 535b between adjacent magnets, the magnets having protrusions on said mating surfaces that protrude through holes in the center of said springs. Asymmetry of the holes and protrusions can prevent incorrect assembly of the spring and magnet assembly. A sufficient cross-sectional area of holed and fully mating protrusions between magnets will provide sufficient flux coupling between magnet sections.

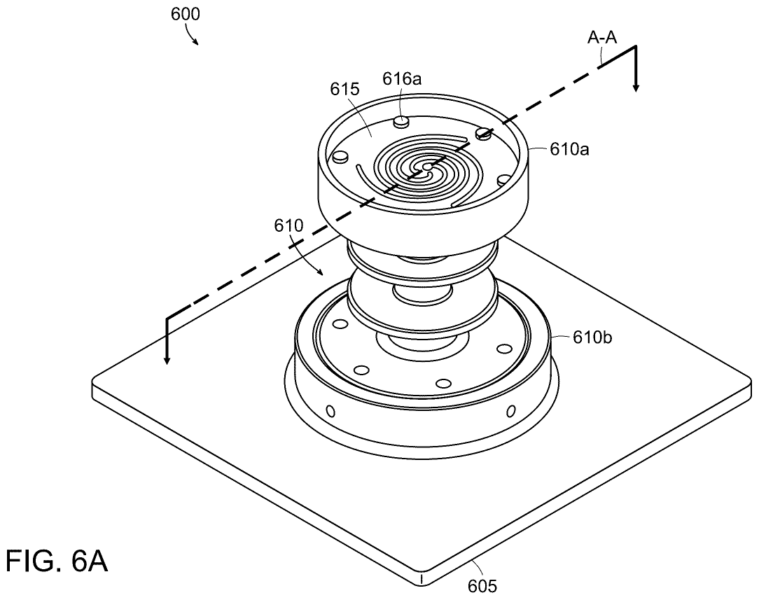

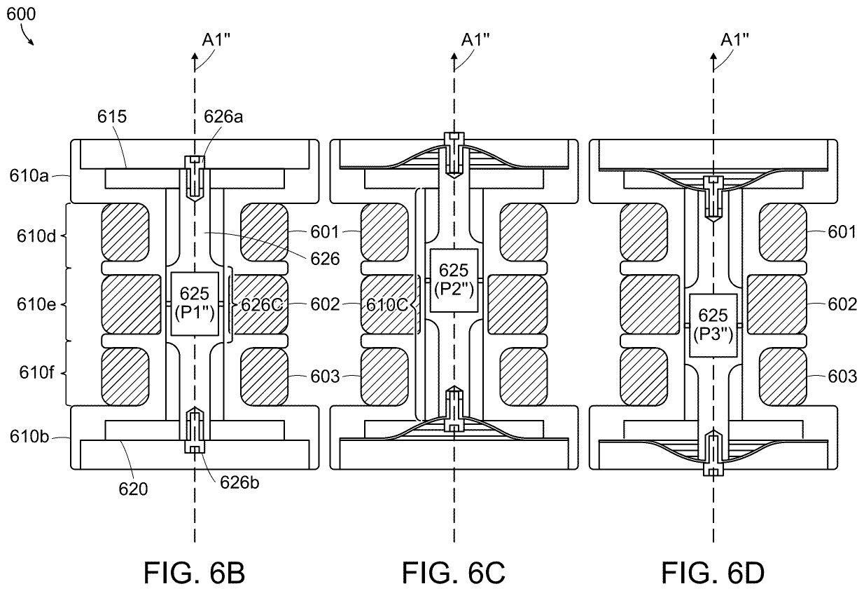

FIGS. 6A-6D illustrate another exemplary aspect of an energy harvesting device/energy generator 600 that is configured to generate electrical energy from vibrations in the environment that the generator 600 is provided in/on (e.g., on an asset, as described above). FIG. 6A is an isometric view of the energy harvesting device 600 and FIGS. 6B-6D are cross sectional views of the energy harvesting device 600, as seen from a section A-A of FIG. 6A, depicting three distinct instances of the device 600 as it operates, as will be described in greater detail below.

As shown in FIG. 6A, the energy harvesting device 600 can include a housing 610 and a first spring 615 (e.g., a magnetically non-conductive spring) provided at a first end 610a of the housing 610. In some aspects, the first spring 615 can be fastened to the first end 610a of the housing 610 by a plurality of screws (e.g., screws 616a). In some aspects, the energy harvesting device 600 can also be coupled to a platform 605 at a second end 610b of the housing 610. The platform 605 can be used as a coupling base between the energy harvesting device and an asset being monitored. As shown in FIGS. 6B-6D, the energy harvesting device 600 can also include a second spring 620 (e.g., a magnetically non-conductive spring) provided at a second end of the housing 610b and a first magnet 625 that is provided between the first spring 615 and the second spring 620. The second spring 620 can be fastened to the second end 610b of the housing 610 by a plurality of screws, similarly to the first spring 615, as shown in FIG. 6A. In some aspects, the first and second springs 615, 620 can be planar springs that are oriented in parallel along a first axis A1″ and can each have an axial stiffness along the first axis A1″ and a relatively higher radial stiffness with respect to first axis A1. In some aspects, the radial stiffness is many orders of magnitude greater than axial stiffness. In some aspects, the axial stiffness of the springs described herein can be designed to achieve a desired oscillating frequency of the device 600, the designs of which are described in greater detail below. The first magnet 625 can be tethered to the first spring 615 and the second spring 620, along the first axis A1″ by a connecting rod 626. In some aspects, the connecting rod 626 can be made from a relatively rigid, magnetically non-conductive material (e.g., plastic or the like). In some aspects, the connecting rod 626 can be coupled to the first spring 615 and the second spring 620 by screws 626a, 626b, respectfully, however, other means for fastening the connecting rod 626 to the first and second springs 615, 620 is also realized. In some aspects, the first magnet 625 can coupled to a center 626c of the connecting rod 626, which can be sized to fit the first magnet 625 via an interfere press fit. Additionally, in some aspects, the center 626c of the connecting rod 626 can be coupled to the first magnet using an adhesive or other binding agent. In some aspects, a center of the first magnet 625 can be hollow along the first axis (not shown). In this case, the connecting rod 626 can be configured to extend though the hollow center of the first magnet 625 and couple to the internal walls of the hollow center using an adhesive or other binding agent.

The first and second springs 615, 620 and the connecting rod 626, in combination, advantageously allow for motion of the first magnet along the first axis A1″, while minimizing “in plane” or “radial” motion along axes that are perpendicular to the first axis A1″ (e.g., minimizing the deviation of the first magnet 625 from a centerline of the device, defined by the first axis A1″). Additionally, by using a pair of springs (e.g., first and second springs 615, 620), any rocking motion of the first magnet 625 can also be minimized.

In some aspects, the housing 610 can also include a hollow shaft 610c configured to house the first magnet 625 as it oscillates. However, the hollow shaft 610c is not required, as the motion of the first magnet 625 along the first axis A1″ is constrained by the first and second springs 615, 620 and the connecting rod 626, as described above. In some aspects, interior walls of the hollow shaft 610c can be textured, similarly as described above in reference to FIG. 2, to minimize viscous damping of the oscillation of the first magnet 625 and to allow for any debris that exists within the shaft 610c to pass by the first magnet 625 as it oscillates.

The energy harvesting device 600 can also include one or more turns of wire 601, 602, 603 that are provided on the housing 610, circumferentially around the first axis A1″, similarly to the energy harvesting devices 200-500. As described above, the one or more turns of wire of the energy harvesting device 600 each have a first terminal end and a second terminal end (not shown), which can be coupled to an electronics module of the energy harvesting device 600 (e.g., the electronics module 110 of FIG. 1). In some aspects, the housing 610 can be split or arranged into multiple sections 610d, 610e, 610f, as shown in FIGS. 6B-6D, and the one or more turns of wire 601, 602, 603 can be provided around one or more of the sections 610d, 610e, 610f, respectively. As shown in FIGS. 6B-6D, section 610d is located above the first magnet 625 when the first magnet is at the equilibrium position P1″, and the section 610f is located below the first magnet 625 when the first magnet is at the equilibrium position P1″. This design is particularly advantageous for maximizing electrical induction in the one or more turns of wire of the device at small amplitude oscillations of the first magnet 625 relative to the resistance and inductance of the wire. Specifically, at small vibration amplitudes, the turns of wire 602 surrounding the first magnet 625 when the first magnet is at the equilibrium position P1″ see relatively no time varying magnetic flux, thus adding to the electrical inductance and resistance but not inducing a significant voltage. However, the turns of wire 601, 603 surrounding sections 610d and 610f, respectively, located above and below the first magnet 625, see relatively greater time varying magnetic flux at small vibration amplitudes, thereby maximizing the electrical induction at small motions relative to the resistance and inductance of the wire.

In some aspects, the device 600 can be modified using any of the designs described above in reference to FIGS. 2A-5. For example, in some aspects, the device 600 can by modified to have a lower-profile “pancake” design simply by relocating the first and second springs 615, 620 to positions adjacent the free magnet 625 (e.g., similarly as shown as in FIGS. 4-5). In some aspects, this can be achieved, for example, by omitting the turns of wire 602 from the section 610e, and instead utilizing the space provided by section 610e to relocating the first and second springs 615, 620 to positions adjacent the free magnet 625. In this case, the device 600 would include the turns of wire 601, 603 surrounding sections 610d and 610f, respectively, and the first and second springs 615, 620 would be provided at section 610e (e.g., similarly to the coils 530a, 530b and springs 535a, 535b of FIG. 5).

During operation, when there are no vibrational or impact forces imparted on the device 600, the energy harvesting device 600 can be at rest, with the first magnet 625 in equilibrium position P1″, as shown in FIG. 6B. In response to a vibration or impact experienced by the device 600, the first and second springs 615, 620 can be configured respond to the vibration or impact by oscillating along the first axis A1″, thereby causing the first magnet 625 to be set into an oscillatory motion defined by the reciprocal movement of the first and second springs 615, 620, as shown in FIGS. 6C and 6D. FIG. 6C depicts the energy harvesting device 600 in a first position of maximum displacement, with the first magnet 625 in a first oscillating position P2″, and FIG. 6D depicts the energy harvesting device 600 in a second position of maximum displacement, with the first magnet 625 in a second oscillating position P3″. Accordingly, in response to a vibration or impact experienced by the device 600, the first magnet 615 can oscillate along the first axis A1″ between the first oscillating position P2″ and the second oscillating position P3″ (or any smaller amplitude positions between P2″ and P3″), thereby inducing a voltage between the first terminal ends and the second terminal ends of the one or more turns of wire 601, 602, 603. The voltage can then be sent to the electronics module and processed as described above.

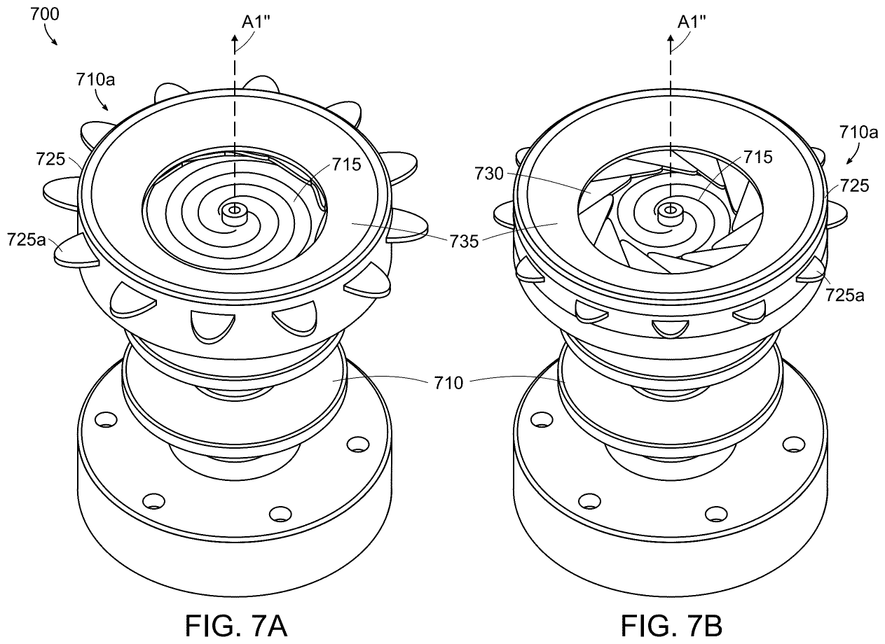

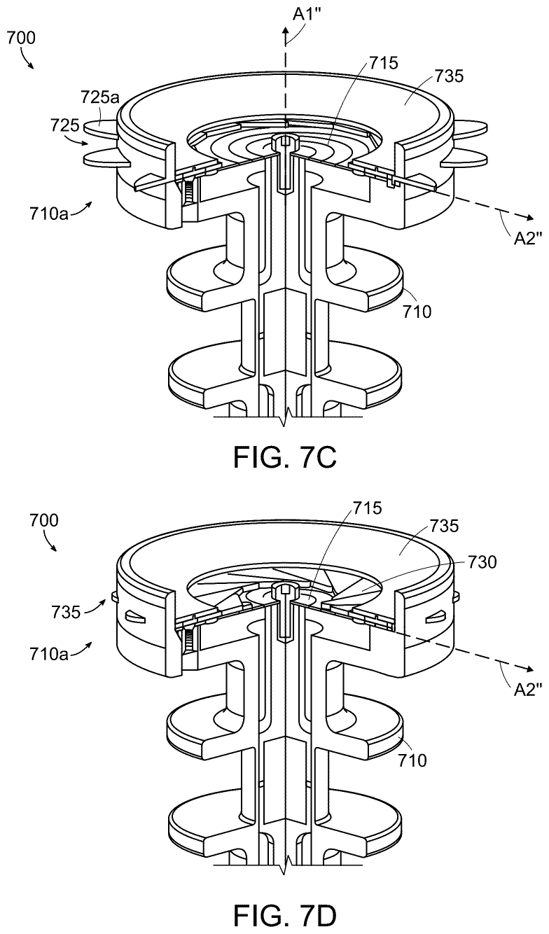

In some aspects, the energy harvesting device 600 can also include an annular shutter that can be provided at the first end of the housing and can be adjusted to increase/decrease a spring rate or “stiffness” of the device 600, which in turn increases/decreases a resonance frequency of the device 600. Increased stiffness (reduced aperture) increases the resonant frequency. Therefore the resonant frequency may be adjusted by adjusting the aperture as described in greater detail below in regard to FIGS. 7A-7D.

FIGS. 7A-7B illustrate isometric views of another aspect of an energy harvesting device 700. In some aspects, the energy harvesting device 700 can be similar to the energy harvesting device 600, as described above, accordingly, like components will not be described. Similarly to as described above in reference to energy harvesting device 600, the energy harvesting device 700 can include a housing 710 and a first spring 715 fastened to a first end 710a of the housing 710 (e.g., screws 616a, as shown in FIG. 6A). In some aspects, the first spring 715 and the second spring (not shown) can be planar springs that are oriented in parallel along the first axis A1″, and can each have an stiffnesses, as described above in reference to FIGS. 6A-6D. Simplistically, the stiffness of the planar springs depends on the effective length of the spiral leaf members. Longer leaf springs are less stiff. The energy harvesting device 700 can additionally include an annular shutter assembly 720 provided at the first end 710a of the housing 710 and operatively coupled to the first spring 715. The radius of the aperture determines the free length of the spiral leaves of the planar spring and therefore determines its stiffness. In some aspects, the annular shutter assembly 720 can include an adjustment mechanism 725 provided within the first end 710a of the housing. In some aspects, the adjustment mechanism 725 can be a mechanically or electrically driven cam that is configured to rotate within the first end 710a of the housing 710 about the first axis A1″ to modify the first stiffness of the first spring 715 along the first axis A1″, as described in greater detail below. The adjustment mechanism 725 can include a plurality of tabs (e.g., tabs 725a) which can be gripped by a user in order to rotate the adjustment mechanism 725 within the first end 710a of the housing 710. Alternatively, in some aspects, rather than having the plurality of tabs 725a, the external surface of the adjustment mechanism 725 can simply be smooth, or provided with a rubber grip or other texturing, to allow for the user to rotate the adjustment mechanism 725 within the first end 710a of the housing 710. In some aspects, the annular shutter assembly 720 can further include a plurality of blades 730, arranged concentrically around an adjustable diameter central aperture defined by the blades 730, as shown in FIG. 7B. The number of blades 730 can vary depending on the design and desired aperture shape. In some aspects, the plurality of blades 730 can be formed from a nonmagnetic material that has relatively rigid stiffness against deflection of the blades along the first axis A1″, such as titanium, polyimide, liquid crystal plastic, and the like. Additionally, the annular shutter assembly 720 can include an annular ring 735 configured to press the plurality of blades 730 into the first spring 715. In aspects, the plurality of blades 730 can be provided both above and below the spring 715, such that the spring 715 is constrained in both upward and downward deflections.

During operation, the annular shutter assembly 720 can operate similarly to an annular shutter mechanism that controls a size of a camera's aperture. Accordingly, as the adjustment mechanism 725 is rotated back and forth about the first axis A1″, the plurality blades 730 can move inward, toward the center of the spring 715, or outward to either reduce or enlarge the diameter of the central aperture. For example, the central aperture can be actuated between a fully open position, as shown in FIGS. 7A and 7C and any number of more restrictive positions, as shown in FIGS. 7B and 7D. Due to the coupling between the plurality of blades 730 and the first spring 715, as the diameter of the central aperture is widened or narrowed, an effective diameter of the first spring 715 (which is defined by the diameter of the aperture) is also widened or narrowed, thereby changing the first stiffness of the spring 715 along the first axis A1″. Therefore, the annular shutter assembly 720 can be used to tune a resonant frequency of the energy harvesting device 700. While FIGS. 7A-7D only illustrate the annular shutter assembly 720 provided at the first end 710a of the housing 710, it is also realized that an identical annular shutter assembly can be provided symmetrically at the second end of the housing and can operate in the same way as the annular shutter assembly 720.

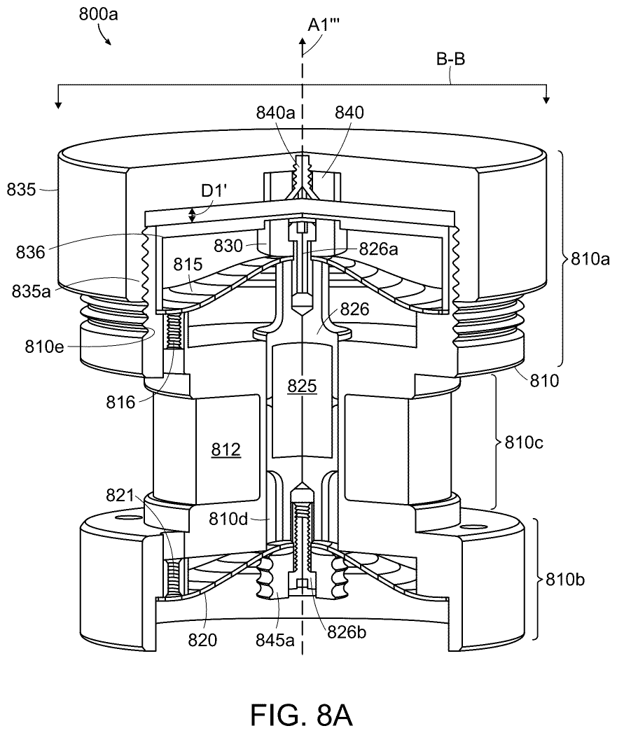

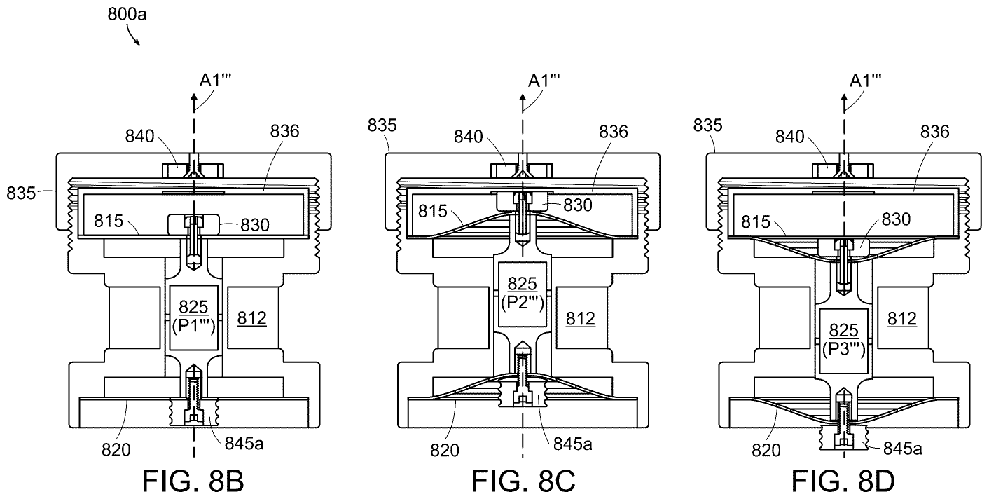

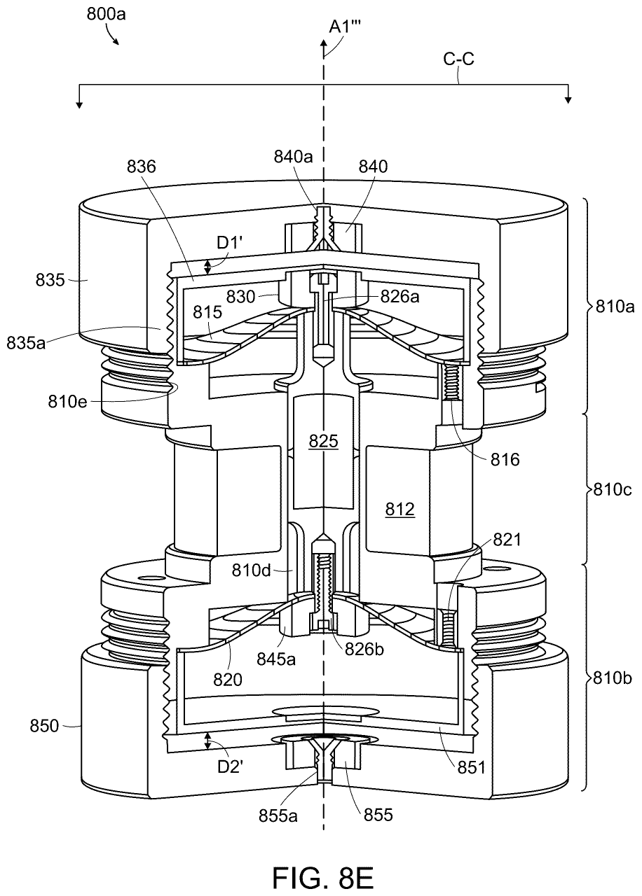

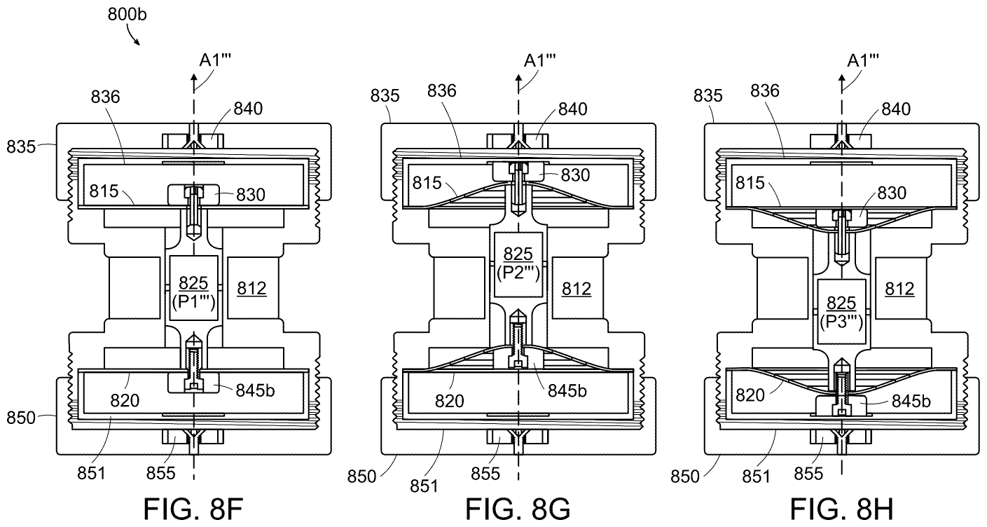

FIGS. 8A-8H illustrate two variations of another exemplary aspect of an energy harvesting device 800a, 800b that is configured to generate electrical energy in response to significant vibrations or impacts that are experienced by the device 800a, 800b or an asset that the device 800a, 800b is coupled to. In some aspects, the energy harvesting devices 800a, 800b can be similar to the energy harvesting devices 600 and 700 described above, accordingly like components will not be described.

FIG. 8A is a partial cross-sectional view of the energy harvesting device 800a that includes a single adjustable end cap, as will be described in greater detail below. FIGS. 8B-8D are cross sectional views of the energy harvesting device 800a, as seen from a section B-B of FIG. 8A, depicting three distinct instances of the device 800a as it operates, as will be described in greater detail below. FIG. 8E is a partial cross-sectional view of the energy harvesting device 800b that includes a pair of adjustable end caps provided at both the first and second ends of the housing, as will be described in greater detail below. FIGS. 8F-8H are cross sectional views of the energy harvesting device 800b, as seen from a section C-C of FIG. 8E, depicting three distinct instances of the device 800b as it operates, as will be described in greater detail below.

As shown in FIG. 8A, the energy harvesting device 800a can include a housing 810 and a first spring 815 provided at a first end 810a of the housing 810. In some aspects, the first spring 815 can be fastened to the first end 810a of the housing 810 by a plurality of screws 816, as shown in FIGS. 8B-8D. The energy harvesting device 800a can also include a second spring 820 provided at a second end of the housing 810b and a first magnet 825 that is provided between the first spring 815 and the second spring 820. The second spring 820 can be fastened to the second end 810b of the housing 810 by a plurality of screws 821, as shown in FIG. 8A. The first and second springs 815, 820 can be planar springs, similarly to as described above. The first magnet 825 can be tethered to the first spring 815 and the second spring 820, along a first axis A1′″ by a connecting rod 826 which can be coupled to the first spring 815 and the second spring 820 by screws 826a, 826b, respectfully, however, other means for fastening the connecting rod 826 to the first and second springs 815, 820 is also realized, as described above. Further, the springs may be directly coupled to the first magnet 825, as described above. The energy harvesting device 800a also includes one or more turns of wire 812 that are provided on a middle section 810c of the housing 810, circumferentially around the first axis A1′″, similarly to the energy harvesting devices 200-700. As described above, the one or more turns of wire 812 of the energy harvesting device 800a have a first terminal end and a second terminal end (not shown), which can be coupled to an electronics module of the energy harvesting device 800a (e.g., the electronics module 110 of FIG. 1).

In some aspects, the housing 810 can also include a hollow shaft 810d provided in the middle section 810c of the housing 810 and configured to house the first magnet 825 as it oscillates. However, the hollow shaft 810d is not required, as the motion of the first magnet 825 along the first axis A1′″ is constrained by the first and second springs 815, 820 and the connecting rod 826, as described above. In some aspects, interior walls of the hollow shaft 810d can be textured or provided with features similarly to as described above. Alternatively, in some aspects, air flow channels can be provided along the first axis A1 from a top surface of the first magnet 225 through the top of the housing 810 and from a bottom surface of the first magnet 225 through the bottom of the housing 810 (e.g., similar to the air flow channels described above in reference to FIGS. 2A-2B). By providing the air flow channels, as described above, air that is displaced by the first magnet 825 can be flown out of the device 800a, thereby reducing aerodynamic drag without having to texture the walls of the hollow shaft 810d or hollow out a center of the first magnet 825. In some aspects, a housing 810 of the energy harvesting device 800 can be shorter in an axial direction (e.g., along an axis A1′″) than the housing 610 of the energy harvesting device 600. For example, as shown in FIG. 8A, the housing 810 can be comprised of only the single mid-section 810c, rather than the multiple sections 610c, 610d, 610e, as shown in FIGS. 6B-6D. Alternatively, in some aspects, the housing 810 of the energy harvesting device 800a can be designed to be even shorter in an axial direction (e.g., along an axis A1′″), by attaching the magnet 825 to the springs 815 and 820 directly. However, it is also realized that the housing 810 can also include multiple sections, similarly to as shown in FIGS. 6B-6D.

Additionally, as shown in FIGS. 8A-8D, the energy harvesting device 800a can include a first collar 830 provided in a top surface of the first spring 815, in alignment with the first axis A1′″. In some aspects, the first collar 830 can be formed in the shape of a washer and can be coupled to the first spring 815 by the screw 826a that couples first spring 815 to the connecting rod 826. In some aspects, the energy harvesting device 800a can also include an adjustable cap 835 that can be removably coupled to the first end 810a of the housing 810. The cap 835 can include female threads 835a provided on an interior wall thereof which are configured to mesh with male threads 810e provided on an exterior of the first end 810a of the housing 810. However, other mechanisms for coupling the adjustable cap 835 to the first end 810a of the housing 810 are also realized. The adjustable cap 835 can include a first binding magnet 840 that is coupled to an interior surface of the adjustable cap 835, along the first axis A1′″. In some aspects, the first binding magnet 840 can be coupled to the adjustable cap 835 via a screw 840a or other suitable fixation methods.

In some aspects, the energy harvesting device 800a can further include a spacing plate 836 provided between the first collar 830 and the first binding magnet 840 along the first axis A1′″. In some aspects, a distance between a mounting plane of first spring 815 (e.g., a plane defined by the first spring 815 when the first magnet 825 is in an equilibrium position P1″, as shown in FIG. 8B) and a bottom surface of the spacing plate 836 remains constant. Therefore, a maximum possible displacement of the first spring 815 is constant. The first collar 830 can be made from a magnetic material and the spacing plate 836 can be made from a non-magnetic material, and the device 800a can be tuned as explained below, such that when the first collar 830 comes into contact with the spacing plate 836, a first attractive magnetic force is generated between the first collar 830 and the first binding magnet 840 that is sufficient to retain the first spring 815, the second spring 820 and the first magnet 825 in a first pretensioned state, as shown in FIG. 8C. When the first spring 815, the second spring 820 and the first magnet 825 are moved to the first pretensioned state, the first magnet 825 is moved to a loaded position P2′″, as shown in FIG. 8C.

During operation, the first magnet 825 can be moved from the equilibrium position P1′″, as shown in FIG. 8B, to the loaded position P2′″, as shown in FIG. 8C. In some aspects, this can be achieved by manually pressing an external facing surface of the second spring 820 upward, toward the first spring 815. In some aspects, the energy harvesting device 800a can further include a second collar 845a provided in a bottom surface of the second spring 820, in alignment with the first axis A1′″. In some aspects, the second collar 845a can be formed in the shape of a washer and can be coupled to the second spring 820 by the screw 826b that couples second spring 820 to the connecting rod 826. In this case, the first magnet 825 can be moved from an equilibrium position P1′″ to the loaded position P2′″ by manually pressing on the second collar 845a. Due to the coupling of the first and second springs 815, 820 via the connecting rod 826, the pressing of the external facing surface of the second spring 820 upward causes the first spring 815 to move upward, until the first collar 830 contacts a bottom surface of the spacing plate 836, thereby establishing the first pretensioned state via the first attractive magnetic force between the first binding magnet 840 and the first collar 830. In some aspects, the adjustable cap 835 can be rotated (e.g., by a user) about the first axis A1′″ to provide adjustment of a distance D1′ between the first binding magnet 840 and a top surface of the spacing plate 836, thereby adjusting a resultant binding force between the collar 830 and the first binding magnet 840, when the first magnet 825 is in the loaded position P2′″. Specifically, the first attractive magnetic force can be tuned to be greater than a first restitution force that is generated by extending the first and second springs 815, 820 into the first pretensioned state. Therefore, a resultant binding force is established between the first collar 830 and the first binding magnet 840, where the resultant binding force is defined as the first attractive magnetic force minus the first restitution force that is generated by extending the first and second springs 815, 820 into the first pretensioned state. Because the distance between the first spring 815 and the spacing plate 836 remains constant, the first restitution force that is generated by extending the first and second springs 815, 820 into the first pretensioned state also remains constant. Therefore, the resultant binding force can be adjusted by modifying the distance D1′, as described above. Modifying the distance D1′ modifies the first attractive magnetic force that is generated between the first collar 830 and the first binding magnet 840. Generally, the magnetic attractive force follows and inverse relationship with D1. Accordingly, the resultant binding force can be increased by rotating the adjustable cap 835 such that the distance D1′ is decreased, thereby increasing the first attractive magnetic force. Similarly, the resultant binding force can be decreased by rotating the adjustable cap 835 such that the distance D1′ is increased, thereby reducing the first attractive magnetic force.

The first magnet 825 can be configured to remain in the loaded position P2′″, until the energy harvesting device 800a experiences a vibration or impact of sufficient energy to overcome the resultant binding force and cause acceleration of free magnet 825 away from the first pretensioned state. Responsive to a vibration or impact force on the energy harvesting device 800a that provides sufficient energy to overcome resultant binding force and accelerate the first magnet 825, the collar 830 can be configured to separate from the first pretensioned state. When the binding magnet 830 separates sufficiently distant from the first pretensioned state, the restitution force that is generated by extending the first and second springs 815, 820 causes the first and second springs 815, 820 and the first magnet 825 to rebound past the equilibrium position P1′″, as shown in FIG. 8B, to a second maximum spring tension state P3′″, as shown in FIG. 8D. As the first magnet moves along the first axis A1′″ from the loaded position P2″ to the second maximum spring tension state P3″, it causes a voltage to be generated between the first and second terminal ends of the coil of wire that surrounds the housing, as described above. The second position P′″ depends on the strength of the shock and the stiffness of the springs,

In some aspects, the first pretensioned state can be tuned such that, after the first collar 830 is separated from the first pretensioned state, the first magnet 825 is configured to oscillate along the first axis A1′″ at some decaying amplitude between the loaded position P2′″ and the second maximum spring tension state P3′″, indefinitely. In this case, the device 800a can require a manual reset by the user. This design can be particularly advantageous in a case where the energy harvesting device 800a is monitoring an asset (e.g., a compressor) for fault events that would require immediate attention. In this case, once the binding magnet 830 is separated from the first pretensioned state, the voltage generated by the oscillation of the first magnet 825 can be used to power the device 800a, to send a signal to the user to alert them of the event, as described above in reference to FIG. 1. The user can then be required to go to the location of the device 800a and manually reset the device 800a by pressing the second spring toward the first spring, causing the first collar 830 to recouple to the first binding magnet 840, as described above, thereby reestablishing the first magnet in the loaded position P2″.

Alternatively, in some aspects the first pretensioned state can be tuned such that, after the first collar 830 is separated from the first pretensioned state, the first magnet 825 is configured to perform a single oscillation along the first axis A1′″, from the loaded position P2′″ to the second maximum spring tension state P3′″ and then back to the loaded position P2′″ upon recapture of the first collar 830 by the first binding magnet 840. In this case, after the first magnet 825 completes the single oscillation, the first binding magnet is configured to recouple to the first binding magnet 840, thereby returning the first spring 815, the second spring 820 and the first magnet 825 to the first pretensioned state. This design can be particularly advantageous in a case where the energy harvesting device 800a is monitoring an asset that routinely experiences noteworthy vibrational or impact events that need to be logged or transmitted. Accordingly, in this case, once the binding magnet 830 is separated from the first pretensioned state, the voltage generated by the single oscillation of the first magnet 825 can generate enough power to send a signal to the user to alert them of the event, as described above in reference to FIG. 1, before reestablishing the first pretensioned state, without having to be rest by the user.

In some aspects, the first binding magnet 840 can be coupled a shaft/spring assembly (not shown) that is configured to extend within the adjustable cap 835 (e.g., similarly to the shaft 345 and spring 350 that are provided within the end cap 340 of the energy harvesting device 300), which can function similarly to shaft 345 and spring 350 of the energy harvesting device 300. In this case, the resultant binding force can be further defined as the first attractive magnetic force minus the first restitution force that is generated by extending the first and second springs 815, 820 into the first pretensioned state minus a spring force of the shaft/spring assembly that is provided within the adjustable cap 835, similarly to as described above in reference to FIGS. 3A-3B.

In some aspects, as shown in FIGS. 8E-8H, the energy harvesting device 800b can further include a second collar 845b provided in a bottom surface of the second spring 820, in alignment with the first axis A1′″, that is symmetrical to the first collar 830. In some aspects, the second collar 845b can be formed in the shape of a washer and can be coupled to the second spring 820 by the screw 826b that couples second spring 820 to the connecting rod 826. Additionally, in some aspects, the energy harvesting device 800b can also include an second adjustable cap 850 that can be removably coupled to the second end 810b of the housing 810. The cap 850 can be similar to the adjustable cap 835, accordingly, like components will not be described. Accordingly, the second adjustable cap 850 can include a second binding magnet 855, and the housing 810 can further include a second spacing plate 851 provided between the second collar 845b and the second binding magnet 855 along the first axis A1′″. In some aspects, the second binding magnet 855 can be coupled to the adjustable cap 850 via a screw 855a. Similarly to as described above, a distance between the second spring 820 and the second spacing plate 851 remains constant. Additionally, the second collar 845b can be made from a magnetic material and the second spacing plate 851 can be made from a non-magnetic material, and the device 800b can be tuned the same as described above in reference to device 800a. Accordingly, when the first spring 815, the second spring 820 and the first magnet 825 are moved to the second pretensioned state, the first magnet 825 is moved to a second loaded position P3′″, as shown in FIG. 8H. In some aspects, the second adjustable cap 850 can be rotated (e.g., by a user) about the first axis A1′″ to provide adjustment of a distance D2′ between the second binding magnet 855 and a bottom surface of the spacing plate 851, thereby adjusting a second resultant binding force between the second collar 845b and the second binding magnet 855, when the first magnet 825 is in the second loaded position P3″, similarly to as described above.

In this case, during operation, the first magnet 825 can be moved from the equilibrium position P1′″ to either the loaded position P2′″, as shown in FIG. 8G, or the second loaded position P3′″, as shown in FIG. 8H (e.g. corresponding to the second maximum spring tension state P3″, as shown in FIG. 8D). In this case. the first magnet 825 can be configured to remain in either the loaded position P2′″ or the second loaded position P3′″, until the energy harvesting device 800b experiences vibration or impact of sufficient energy to overcome the resultant binding force between either the first collar 830 and the first binding magnet 840, or the second collar 845b and the second binding magnet 855, respectively, and accelerate first magnet 825 toward the opposing loaded position.

For example, in a case where the first magnet 825 is initially in the loaded position P2′″, responsive to a vibration or impact force on the energy harvesting device 800b that exceeds the resultant binding force and causes acceleration of first magnet 825, the first collar 830 can be configured to separate from the first pretensioned state. When the first collar 830 separates from the first pretensioned state, the restitution force that is generated by extending the first and second springs 815, 820 causes the first and second springs 815, 820 and the first magnet 825 to rebound past the equilibrium position P1′″, as shown in FIG. 8F, to the second maximum spring tension state P3′″, as shown in FIG. 8H. However, in this case, due to the addition of the second collar 845b and the second binding magnet 855, as the first magnet 825 moves from the loaded position P2′″ to the second maximum spring tension state P3″, the second collar 845b is configured to be retained by the second binding magnet 855 via the second attractive magnetic force, thereby retaining the first magnet 825 in the second loaded position P3′″.

Accordingly, as shown in FIGS. 8E, the distances D1′, D2′ can be tuned such that, after the first collar 830 is separated from the first pretensioned state, the first magnet 825 is configured to perform a half oscillation along the first axis A1′″, from the loaded position P2′″ to the second loaded position P3′″. In this case, after the first magnet 825 completes the half oscillation, the second collar 845b is configured to contact an upper surface of the second spacing plate 851, where it is retained in the second loaded position P3′″ via the second attractive magnetic force between the second collar 845b and the second binding magnet 855. In this case, once the first collar 830 is separated from the first pretensioned state, the voltage generated by the half oscillation of the first magnet 825 can generate enough power to send a signal to the user to alert them of the event, as described above in reference to FIG. 1, before establishing the second loaded position P3′″, without having to be rest by the user. Such an arrangement implements a bistable shock sensor. Bistable operation requires that the shock or impact energy experienced by the device 800b be sufficient to overcome the resultant binding force between the collars and the binding magnets of the device 800b, and accelerate the first magnet 825 with sufficient kinetic energy to overcome the spring energy from springs 815, 820 from one maximum spring tension state to the other such that the binding magnets of the device are able to capture the collars of the device as the first magnet 825 moves from between the loaded positions P2′″, and P3′″.

FIG. 9 is a diagram illustrating an exemplary planar spring 900 according to the subject matter described herein. The planar spring 900 can be used as the springs in any of the energy generating devices described herein. Key design attributes of these springs include, but are not limited to, spring material selection, cyclical fatigue predictions, linear spring rate, deflection/travel requirements, and radial stiffness.

In some aspects, a radial stiffness of the planar springs 900 is determined by a width 905 of planar sections 910, the effective length of the spiral sections 910, the number of parallel sections, and the shear stiffness of the spring material. When used in the energy harvesting devices described herein (e.g., devices 200-800b), the radial stiffness, kᵣ, of the springs 900 can be designed to satisfy a minimal design condition: (mₐ*g<kᵣ*s), where mₐ*g is a force of gravity on a mass of the moving components of the devices (e.g., a mass of the first spring 815, the second spring 820 and the first magnet 825, in reference to FIG. 8A), kᵣ is the radial stiffness of the springs 900, s is a spacing between the moving components of the devices and the sidewalls of the housing (e.g., a spacing between the connecting rod 826 and the interior walls of the hollow shaft 810d, in reference to FIG. 8A). In some cases, for example in the case of the energy harvesting device 700, an effective radius 915 of the springs 900 can be modified using the annular shutter assembly 720, as described above to alter the spring constant, kᵣ. By having a radial stiffness, kᵣ, that satisfies that condition for all iris apertures, contact between the moving and stationary components of the devices described herein can be prevented. This is especially important in cases, for example, where the axis of movement (e.g., axis A′″ in reference to FIG. 8A is oriented horizontally, or perpendicular to the direction of gravity). Larger radial stiffnesses will also prevent contact under radial vibrations or impacts experienced by the devices described herein.

In some aspects, an axial stiffness of the planar springs 900 (e.g., a stiffness along axis A1′″ in reference to FIG. 8A) can be determined by a thickness of the spring 900 (e.g., in a direction into the page of FIG. 9) instead of the width of a section. The axial stiffness, kₐ can be much smaller than the radial stiffness kᵣ, which allows the springs 900 to constrain the radial motion to very small displacements against large forces while allowing the moving components of the devices to have large motions axially under the influence of small vibrations. This design is necessary to obtain a large time varying magnetic flux in the area enclosed by the turns of wire of the energy harvesting devices described herein. By way of a nonlimiting example, it may be desired to allow the spring 900 to exhibit 1 mm or more of axial motion at 0.1 g vibrational acceleration but to not make contact under 2 g of lateral acceleration with 0.1 mm spacing. In this case the spring 900 can be designed such that a width to thickness ratio of the spring 900 is at least (2 g/0.1 mm)/(0.1 g/1 mm) or 200:1.

In some aspects, the planar springs 900 can also include a plurality of radial holes 920 and a central hole 925. The plurality of radial holes 920 can be provided to fasten the springs 900 to the housings of the energy harvesting devices described herein (e.g., to fasten the spring 915 to the first end 810a of the housing 810 using the screws 816, as shown in FIG. 8A). Similarly, the central hole 925 can be provided to fasten the springs 900 to a connecting rod or moving magnet of the energy harvesting devices described herein (e.g. to fasten the first spring 815 to the connecting rod 826 or the first magnet 825 using the screw 826a, as shown in FIG. 8A).

Certain exemplary aspects have been described to provide an overall understanding of the principles of the structure, function, manufacture, and use of the systems, devices, and methods disclosed herein. One or more examples of these aspects have been illustrated in the accompanying drawings. Those skilled in the art will understand that the systems, devices, and methods specifically described herein and illustrated in the accompanying drawings are non-limiting exemplary aspects and that the scope of the subject matter is defined solely by the claims. The features illustrated or described in connection with one exemplary aspect may be combined with the features of other aspects. Such modifications and variations are intended to be included within the scope of the subject matter. Further, in the present disclosure, like-named components of the aspects generally have similar features, and thus within a particular aspect each feature of each like-named component is not necessarily fully elaborated upon.

The descriptions and examples herein refer to magnetic binding, attractive, or repulsive forces and mechanical forces from shock, impact, or vibration. In such cases the use of the term force is a simplification, and it is understood that the energy of the mechanical source must be sufficient to exceed the binding energy of a bound state in order to free the bound system and impart acceleration to the magnet or magnet and spring assemblies.

In places it is specified that connecting rods and springs are made of magnetically non-conductive materials, i.e., materials of low magnetic permeability. The subject matter could function with materials of any permeability, although with potentially unwanted magnetic and electrical generation performance.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be combined with the use of a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the subject matter based on the above-described aspects. Accordingly, the present application is not to be limited by what has been particularly shown and described, except as indicated by the appended claims. All publications and references cited herein are expressly incorporated by reference in their entirety.

Further non-limiting aspects or embodiments are set forth in the following numbered examples:

Example 1: An energy harvesting device comprising: a housing; a first magnet provided at a first end of the housing; a free magnet provided between the first magnet and a second end of the housing along a first axis, wherein the first magnet and the free magnet arranged such that the free magnet is repelled by the first magnet; and a collar provided at the second end of the housing, wherein the collar is made from a magnetic material such that an attractive magnetic force is generated between the collar and the free magnet that is sufficient to retain the free magnet in a normally bound state proximal to the collar; and one or more turns of wire provided circumferentially around the first axis between the first magnet and the second end, each of the one or more turns of wire having a first terminal end and a second terminal end, wherein, responsive to an impact on the housing with an energy that is sufficient to separate the free magnet from the normally bound state and accelerate the free magnet toward the first magnet, the free magnet is accelerated toward the first magnet along the first axis, repelled by the first magnet and accelerated back toward the collar, thereby inducing a voltage across the first terminal end and the second terminal end.

Example 2: The energy harvesting device of example 1, wherein the free magnet is configured to recouple to the collar after being repelled by the first magnet, thereby reestablishing the normally bound state.

Example 3: The energy harvesting device of example 1, further comprising: a shaft extending through the collar along the first axis and having a first end coupled to a second magnet, wherein the free magnet and the second magnet are arranged such that the free magnet is repelled by the second magnet; and a spring operatively coupled to the shaft, wherein the shaft and the spring are in a loaded state when the free magnet is in the normally bound state, wherein a spring force of the spring in the loaded state is less than the attractive magnetic force between the collar and the free magnet, wherein, responsive to the impact, the shaft and the spring are configured to extend into an unloaded state causing the shaft to propel the second magnet toward the first magnet.

Example 4: The energy harvesting device of example 3, wherein, after the free magnet is separated from the normally bound state, the free magnet is configured to oscillate between the first magnet and the second magnet along the first axis in response to a vibration of the housing, thereby inducing a second voltage across the first terminal end and the second terminal end.

Example 5: The energy harvesting device of example 4, wherein the shaft further comprises a second end opposite the first end that protrudes from the second end of the housing wherein, after the free magnet is separated from the normally bound state, a user can pull the second end of the shaft to cause the shaft and the spring to move from the unloaded state to the loaded state, thereby reestablishing the normally bound state.

Example 6: The energy harvesting device of example 3, further comprising an adjustment mechanism operatively coupled to the spring and configured to allow for adjustment of the loaded state, thereby adjusting the spring force.

Example 7: The energy harvesting device of example 3, wherein the collar is configured to short circuit a magnetic field of the second magnet when the free magnet is in the normally bound state.

Example 8: The energy harvesting device of example 1, wherein the energy harvesting device is coupled to an asset and the vibration or the impact force are generated by or experienced by the asset.

Example 9: The energy harvesting device of example 8, wherein the asset is any one of a machine, a machine component, or a vehicle.

Example 10: The energy harvesting device of example 8, wherein the asset is a shipping container or pallet.

Example 11: The energy harvesting device of example 1, wherein the housing further comprises a hollow shaft configured to house the free magnet and wherein interior walls of the hollow shaft are textured such that air or debris within the shaft can pass by the free magnet as it oscillates, thereby minimizing viscous damping of the oscillation of the free magnet.

Example 12: The energy harvesting device of example 11, wherein the texture of the interior walls of the hollow shaft is any one of slotted, spined, rifled, ridged or fluted.

Example 13: The energy harvesting device of example 1, wherein the housing further comprises a hollow shaft configured to house the free magnet and the energy harvesting device further comprises: a plurality of springs operatively coupling the free magnet to the interior of the hollow shaft, wherein the plurality of springs are oriented in parallel along the first axis and each have a first stiffness along the first axis and a relatively higher second stiffness along a second axis that is perpendicular to the first axis.

Example 14: The energy harvesting device of example 13, wherein the plurality of springs are planar springs.

Example 15: The energy harvesting device of example 1, wherein a center of the free magnet along the first axis is hollow.

Example 16: The energy harvesting device of example 15, further comprising a wire or a rod extending though the center of the free magnet and configured to guide the oscillatory motion of the free magnet along the first axis.

Example 17: The energy harvesting device of example 1, further comprising a flange provided at the second end of the housing between the free magnet and the collar when the free magnet is in the normally bound state.

Example 18: The energy harvesting device of example 1, further comprising a low magnetic reluctance material disposed circumferentially outside of the one or more turns of wire.

Example 19: The energy harvesting device of example 18, wherein the low magnetic reluctance material is a soft iron.

Example 20: The energy harvesting device of example 1, further comprising: an electronics module electrically coupled to the first terminal end and the second terminal end of the one or more turns of wire, wherein the voltage induced across the first terminal end and the second terminal end of the one or more turns of wire is configured to power the electronics module to transmit a data characterizing the vibration or the impact force to an external device.

Example 21: The energy harvesting device of example 20, further comprising one or more sensors electrically coupled to the electronics module, wherein the voltage induced across the first terminal end and the second terminal end of the one or more turns of wire is further configured to power the one or more sensors to acquire metadata corresponding to the vibration or the impact force and wherein the electronics module is configured to transmit the metadata to the external device.

Example 22: The energy harvesting device of example 21, wherein the one or more sensors include an accelerometer and the metadata comprises a peak acceleration of the energy harvesting device.

It should be noted that the exemplary energy harvesting devices described above could also be variously combined with any of the other energy harvesting devices described herein, as would be appreciated by one skilled in the art.

1. An energy harvesting device comprising:
a housing;
a first magnet provided at a first end of the housing;
a second magnet provided at a second end of the housing, wherein the first magnet and the second magnet are aligned along a first axis;
a free magnet provided between the first magnet and the second magnet along the first axis, wherein the first magnet, the free magnet and the second magnet arranged such that the free magnet is repelled by both the first magnet and the second magnet, thereby causing the free magnet to oscillate between the first magnet and the second magnet along the first axis in response to a vibration of the housing; and
one or more turns of wire provided circumferentially around the first axis between the first magnet and the second magnet, each of the one or more turns of wire having a first terminal end and a second terminal end, wherein oscillation of the free magnet between the first magnet and the second magnet along the first axis induces a voltage across the first terminal end and the second terminal end.

2. The energy harvesting device of claim 1, further comprising an adjustment mechanism operatively coupled to the first magnet and configured to allow for adjustment of a distance between the first magnet and the second magnet along the first axis.

3. The energy harvesting device of claim 1, wherein the housing further comprises a hollow shaft configured to house the free magnet and wherein interior walls of the hollow shaft are textured such that air or debris within the shaft can pass by the free magnet as it oscillates, thereby minimizing viscous damping of the oscillation of the free magnet.

4. The energy harvesting device of claim 3, wherein the texture of the interior walls of the hollow shaft is any one of slotted, spined, rifled, ridged or fluted.

5. The energy harvesting device of claim 1, wherein the housing further comprises a hollow shaft configured to house the free magnet and the energy harvesting device further comprises:
a plurality of springs operatively coupling the free magnet to the interior of the hollow shaft, wherein the plurality of springs are oriented in parallel along the first axis and each have a first stiffness along the first axis and a relatively higher second stiffness along a second axis that is perpendicular to the first axis.

6. The energy harvesting device of claim 5, wherein the plurality of springs are planar springs.

7. The energy harvesting device of claim 1, wherein a center of the free magnet along the first axis is hollow.

8. The energy harvesting device of claim 7, further comprising a wire or a rod extending though the center of the free magnet and configured to guide the oscillatory motion of the free magnet along the first axis.

9. The energy harvesting device of claim 1, further comprising a low magnetic reluctance material disposed circumferentially outside of the one or more turns of wire.

10. The energy harvesting device of claim 9, wherein the low magnetic reluctance material is a soft iron.

11. The energy harvesting device of claim 1, wherein the energy harvesting device is coupled to an asset and wherein the free magnet is configured to oscillate between the first magnet and the second magnet along the first axis in response to a vibration of the asset.

12. The energy harvesting device of claim 11, wherein the asset is any one of a machine, a machine component or a vehicle.

13. The energy harvesting device of claim 11, wherein the asset is a shipping container or pallet.

14. The energy harvesting device of claim 1, further comprising:
an electronics module electrically coupled to the first terminal end and the second terminal end of the one or more turns of wire,
wherein the voltage induced across the first terminal end and the second terminal end of the one or more turns of wire is configured to power the electronics module to transmit a data characterizing the vibration to an external device.

15. The energy harvesting device of claim 14, further comprising one or more sensors electrically coupled to the electronics module,
wherein the voltage induced across the first terminal end and the second terminal end of the one or more turns of wire is further configured to power the one or more sensors to acquire metadata corresponding to the vibration and wherein the electronics module is configured to transmit the metadata to the external device.

16. The energy harvesting device of claim 15, wherein the one or more sensors comprise an accelerometer and the metadata comprises a peak acceleration of the energy harvesting device.

17.-70. (canceled)
